(19) United States
(12) Patent Application Publication
(10) Pub. No.: US 2016/0297995 A1
(43) Pub. Date: Oct. 13, 2016

(54) POLYIMIDE PRECURSOR, POLYIMIDE, POLYIMIDE FILM, VARNISH, AND SUBSTRATE

(71) Applicant: UBE INDUSTRIES, LTD., Ube-shi, Yamaguchi (JP)

(72) Inventors: Takuya OKA, Ube-shi (JP); Yukinori KOHAMA, Ube-shi (JP); Nobuharu HISANO, Ube-shi (JP)

(21) Appl. No.: 15/028,288

(22) PCT Filed: Oct. 8, 2014
(86) PCT No.: PCT/JP2014/076943

§ 371 Date: Apr. 8, 2016

(30) Foreign Application Priority Data
Oct. 11, 2013 (JP) 2013-214096

(51) Int. Cl. C09D 179/08

(52) U.S. Cl. CPC C09D 179/08

(57) ABSTRACT

A polyimide precursor obtained from a tetracarboxylic acid component including norbornane-2-spiro-α-cyclopentanone-α′-spiro-2″-norbornane-5,5″,6,6″-tetracarboxylic dianhydride, or a derivative thereof, and a diamine component including a diamine, or a derivative thereof, the norbornane-2-spiro-α-cyclopentanone-α′-spiro-2″-norbornane-5,5″,6,6″-tetracarboxylic dianhydride characterized in that the ratio of the peak area of a certain peak is 60% or more in a gas chromatogram obtained by conducting gas chromatography analysis.

### TECHNICAL FIELD

The present invention relates to a polyimide having excellent properties such as high transparency and high heat resistance, and having a very low coefficient of linear thermal expansion up to a high temperature; and a precursor thereof. The present invention also relates to a polyimide film, a varnish comprising a polyimide precursor or a polyimide, and a substrate.

### BACKGROUND ART

With the coming of an advanced information society, the developments of optical materials such as an optical fiber and an optical waveguide in the field of optical communications, and a liquid crystal oriented film and a protective film for a color-filter in the field of display devices have recently advanced. In the field of display devices, in particular, a plastic substrate which is light-weight and excellent in flexibility has been studied as an alternative to a glass substrate, and the development of a display which is capable of being bent and rolled has been intensively conducted. Accordingly, there is need for a higher-performance optical material which may be used for such purposes.

Aromatic polyimides are intrinsically yellowish-brown-colored due to the intramolecular conjugation and the formation of the charge-transfer complex. Consequently, as a means of reducing coloring, methods of developing transparency, for example, by introducing a fluorine atom into the molecule, imparting flexibility to the main chain, introducing a bulky group as a side chain, or the like to suppress the intramolecular conjugation and the formation of the charge-transfer complex are proposed. In addition, methods of developing transparency by the use of a semi-alicyclic or wholly-alicyclic polyimide which do not form a charge-transfer complex in principle are also proposed.

Patent Literature 1 discloses that a thin-film transistor substrate is obtained by forming a thin-film transistor on a film substrate of a transparent polyimide in which the residue of the tetracarboxylic acid component is an aliphatic group by the use of a conventional film-forming process in order to obtain a thin, light-weight and break-proof active matrix display device. The polyimide concretely used herein is prepared from 1,2,4,5-cyclohexane tetracarboxylic dianhydride as the tetracarboxylic acid component and 4,4′-diaminodiphenyl ether as the diamine component.

Patent Literature 2 discloses a process for producing a colorless transparent resin film formed of a polyimide having excellent colorlessness/transparency, heat resistance and flatness, which is used for a transparent substrate for a liquid crystal display device or an organic EL display device, a thin-film transistor substrate, a flexible wiring substrate, and the like, by a solution-casting method using a particular drying step. The polyimide used herein is prepared from 1,2,4,5-cyclohexane tetracarboxylic dianhydride as the tetracarboxylic acid component and α,α′-bis(4-aminophenyl)-1,4-diisopropylbenzene and 4,4′-bis(4-aminophenoxy)biphenyl as the diamine component, and the like.

Patent Literatures 3 and 4 disclose polyimides which are soluble in organic solvents, and prepared using dicyclohexyl tetracarboxylic acid as the tetracarboxylic acid component and diaminodiphenyl ether, diaminodiphenyl methane, 1,4-bis(4-aminophenoxy)benzene, 1,3-bis(4-aminophenoxy)benzene, 2,2-bis[4-(4-aminophenoxy)phenyl]propane, bis[4-(4-aminophenoxy)phenyl]sulfone, bis[4-(4-aminophenoxy)phenyl]ether or m-phenylenediamine as the diamine component.

Such a semi-alicyclic polyimide, in which an alicyclic tetracarboxylic dianhydride is used as the tetracarboxylic acid component and an aromatic diamine is used as the diamine component, combines transparency, bending resistance and high heat resistance. However, such a semi-alicyclic polyimide generally has a great coefficient of linear thermal expansion, and therefore the difference in coefficient of linear thermal expansion between the semi-alicyclic polyimide and a conductive material such as a metal is great, and a trouble such as an increase in warpage may occur during the formation of a circuit board, and there has been a problem of not easily performing a process for forming a fine circuit for use in a display, or the like, in particular.

Patent Literature 5 discloses a polyimide obtained from an alicyclic tetracarboxylic dianhydride containing ester bond and a varied aromatic diamine, and the polyimide of Example 4, for example, has a coefficient of linear thermal expansion at 100° C. to 200° C. of 45.3 ppm/K, which is relatively low. However, the polyimide has a glass-transition temperature of about 300° C., and it is assumed that the film softens and the coefficient of linear thermal expansion becomes much greater at a higher temperature, and there is a risk that a trouble occurs in a process for forming a circuit, which requires low thermal expansibility at a high temperature, as well as at a low temperature.

Non Patent Literature 1 discloses a polyimide in which norbornane-2-spiro-α-cyclopentanone-α′-spiro-2″-norbornane-5,5″,6,6″-tetracarboxylic dianhydride is used as the tetracarboxylic acid component. Non Patent Literature 1 discloses that the polyimide has high heat resistance and also has a high glass-transition temperature. Moreover, Non Patent Literature 1 discloses that the norbornane-2-spiro-α-cyclopentanone-α′-spiro-2″-norbornane-5,5″,6,6″-tetracarboxylic dianhydride used herein comp rises six types of stereoisomers.

Patent Literature 6 discloses a polyimide in which norbornane-2-spiro-α-cyclopentanone-α′-spiro-2″-norbornane-5,5″,6,6″-tetracarboxylic dianhydride and 4,4′-oxydianiline are used, and the like. However, no mention is made of steric structure of norbornane-2-spiro-α-cyclopentanone-α′-spiro-2″-norbornane-5,5″,6,6″-tetracarboxylic dianhydride.

### CITATION LIST

### Patent Literature

Patent Literature 1: JP-A-2003-168800
Patent Literature 2: WO 2008/146637
Patent Literature 3: JP-A-2002-69179
Patent Literature 4: JP-A-2002-146021
Patent Literature 5: JP-A-2008-31406
Patent Literature 6: WO 2011/099518

### Non Patent Literature

Non Patent Literature 1: KOUBUNSHI RONBUNSHU (Japanese Journal of Polymer Science and Technology), Vol. 68, No. 3, P. 127-131 (2011)

### SUMMARY OF INVENTION

### Technical Problem

An object of the present invention is to provide a polyimide prepared using a specific alicyclic tetracarboxylic dianhydride as the tetracarboxylic acid component and preferably using an aromatic diamine as the diamine component, and having excellent properties such as high transparency and high heat resistance, and having a very low coefficient of linear thermal expansion up to a high temperature; and a precursor thereof.

### Solution to Problem

The present invention relates to the following items.

[1]A polyimide precursor obtained from

a tetracarboxylic acid component comprising norbornane-2-spiro-α-cyclopentanone-α′-spiro-2″-norbornane-5,5″,6,6″-tetracarboxylic dianhydride, or a derivative thereof, and

a diamine component comprising a diamine, or a derivative thereof, wherein the norbornane-2-spiro-α-cyclopentanone-α′-spiro-2″-norbornane-5,5″,6,6″-tetracarboxylic dianhydride is characterized in that the ratio of the peak area in the retention time 33.4-33.5 is 60% or more relative to the total peak area in the retention time 31.7-33.5 in a gas chromatogram obtained by conducting gas chromatography analysis under the following conditions:

(Gas Chromatography Analysis Conditions)

Measurement sample: Solution prepared by dissolving 0.25 g of norbornane-2-spiro-α-cyclopentanone-α′-spiro-2″-norbornane-5,5″,6,6″-tetracarboxylic dianhydride in 5 mL of N,N-dimethylacetamide;
Column: “Rtx-5 Amine” made by SHIMADZU GLC Ltd. (length: 30 m);
Column temperature: Temperature is increased from 50° C. to 300° C. at the rate of 10° C./min, and maintained at 300° C.;

### Carrier gas: He;

Flow rate (flow rate of carrier gas): 10 mL/min;
Sample inlet temperature: 290° C.;
Detector temperature: 310° C.;
Amount of injected sample: 1 μL.

[2] The polyimide precursor as described in [1], wherein the polyimide precursor comprises at least one repeating unit represented by the following chemical formula (1):

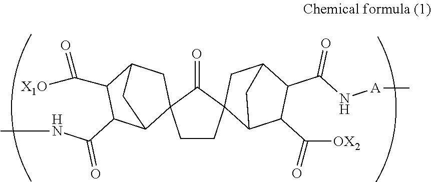

wherein A is a divalent group of an aromatic diamine or an aliphatic diamine, from which amino groups have been removed; and X₁ and X₂ are each independently hydrogen, an alkyl group having 1 to 6 carbon atoms, or an alkylsilyl group having 3 to 9 carbon atoms,

as the repeating unit derived from norbornane-2-spiro-α-cyclopentanone-α′-spiro-2″-norbornane-5,5″,6,6″-tetracarboxylic dianhydride or a derivative thereof, and a diamine or a derivative thereof.

[3] The polyimide precursor as described in [2], wherein the polyimide precursor comprises at least one repeating unit of the chemical formula (1) in which A is a group represented by the following chemical formula (2):

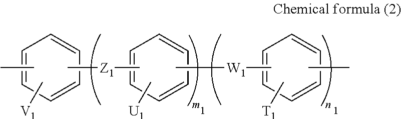

wherein m₁ and n₁ are integers of 0 or more, and m₁ independently represents 0 to 3 and n₁ independently represents 0 to 3; V₁, U₁ and T₁ each independently represent at least one selected from the group consisting of hydrogen atom, methyl group and trifluoromethyl group; and Z₁ and W₁ each independently represent direct bond, or at least one selected from the group consisting of groups represented by the formulas: —NHCO—, —CONH—, —COO— and —OCO—.

[4] The polyimide precursor as described in [3], wherein the polyimide precursor comprises at least two of repeating units of the chemical formula (1) in which A is a group represented by the chemical formula (2).

[5] A polyimide obtained from

a tetracarboxylic acid component comprising norbornane-2-spiro-α-cyclopentanone-α′-spiro-2″-norbornane-5,5″,6,6″-tetracarboxylic dianhydride, or a derivative thereof, and

a diamine component comprising a diamine, or a derivative thereof, wherein the norbornane-2-spiro-α-cyclopentanone-α′-spiro-2″-norbornane-5,5″,6,6″-tetracarboxylic dianhydride is characterized in that the ratio of the peak area in the retention time 33.4-33.5 is 60% or more relative to the total peak area in the retention time 31.7-33.5 in a gas chromatogram obtained by conducting gas chromatography analysis under the following conditions:

(Gas Chromatography Analysis Conditions)

Measurement sample: Solution prepared by dissolving 0.25 g of norbornane-2-spiro-α-cyclopentanone-α′-spiro-2″-norbornane-5,5″,6,6″-tetracarboxylic dianhydride in 5 mL of N,N-dimethylacetamide;
Column: “Rtx-5 Amine” made by SHIMADZU GLC Ltd. (length: 30 m);
Column temperature: Temperature is increased from 50° C. to 300° C. at the rate of 10° C./min, and maintained at 300° C.;

### Carrier gas: He;

Flow rate (flow rate of carrier gas): 10 mL/min;
Sample inlet temperature: 290° C.;
Detector temperature: 310° C.;
Amount of injected sample: 1 μL.

[6] The polyimide as described in [5], wherein the polyimide comprises at least one repeating unit represented by the following chemical formula (3):

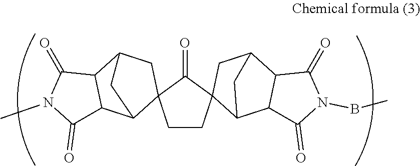

wherein B is a divalent group of an aromatic diamine or an aliphatic diamine, from which amino groups have been removed,
as the repeating unit derived from norbornane-2-spiro-α-cyclopentanone-α′-spiro-2″-norbornane-5,5″,6,6″-tetracarboxylic dianhydride or a derivative thereof, and a diamine or a derivative thereof.

[7] The polyimide as described in [6], wherein the polyimide comprises at least one repeating unit of the chemical formula (3) in which B is a group represented by the following chemical formula (4):

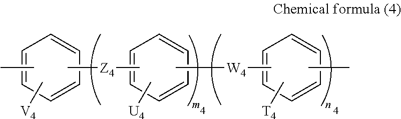

wherein m₄ and n₄ are integers of 0 or more, and m₄ independently represents 0 to 3 and n₄ independently represents 0 to 3; V₄, U₄ and T₄ each independently represent at least one selected from the group consisting of hydrogen atom, methyl group and trifluoromethyl group; and Z₄ and W₄ each independently represent direct bond, or at least one selected from the group consisting of groups represented by the formulas: —NHCO—, —CONH—, —COO— and —OCO—.

[8] A polyimide obtained from the polyimide precursor as described in any one of [1] to [4].

[9] A polyimide film obtained from the polyimide precursor as described in any one of [1] to [4].

[10] A varnish comprising the polyimide precursor as described in any one of [1] to [4], or the polyimide as described in any one of [5] to [8].

[11]A polyimide film obtained using a varnish comprising the polyimide precursor as described in any one of [1] to [4], or the polyimide as described in any one of [5] to [8].

[12]A substrate for a display, a touch panel or a solar battery formed of the polyimide obtained from the polyimide precursor as described in any one of [1] to [4], or the polyimide as described in any one of [5] to [8].

### Advantageous Effects of Invention

According to the present invention, there may be provided a polyimide having excellent properties such as high transparency and high heat resistance, and having a very low coefficient of linear thermal expansion up to a high temperature, for example, up to 300° C. or more, furthermore up to 350° C. or more, and furthermore up to 400° C. or more; and a precursor thereof. The polyimide obtained from the polyimide precursor of the present invention, and the polyimide of the present invention have high transparency and a low coefficient of linear thermal expansion up to a high temperature, which allows easy formation of a fine circuit, and therefore the polyimides may be suitably used for the formation of a substrate for use in a display, or the like. In addition, the polyimides of the present invention may also be suitably used for the formation of a substrate for a touch panel or a solar battery.

### BRIEF DESCRIPTION OF DRAWINGS

FIG. 1 is a gas chromatogram of CpODA-1 which is the tetracarboxylic acid component (norbornane-2-spiro-α-cyclopentanone-α′-spiro-2″-norbornane-5,5″,6,6″-tetracarboxylic dianhydride) used in Examples 1 to 12.

FIG. 2 is a gas chromatogram of CpODA-2 which is the tetracarboxylic acid component (norbornane-2-spiro-α-cyclopentanone-α′-spiro-2″-norbornane-5,5″,6,6″-tetracarboxylic dianhydride) used in Examples 13 to 17.

FIG. 3 is a gas chromatogram of CpODA-3 which is the tetracarboxylic acid component (norbornane-2-spiro-α-cyclopentanone-α′-spiro-2″-norbornane-5,5″,6,6″-tetracarboxylic dianhydride) used in Comparative Examples 1 to 7.

### DESCRIPTION OF EMBODIMENTS

The polyimide precursor of the present invention is obtained from a tetracarboxylic acid component comprising norbornane-2-spiro-α-cyclopentanone-α′-spiro-2″-norbornane-5,5″,6,6″-tetracarboxylic dianhydride, or a derivative thereof, and

a diamine component comprising a diamine, or a derivative thereof. Herein, the derivative included in the tetracarboxylic acid component means tetracarboxylic acid (norbornane-2-spiro-α-cyclopentanone-α′-spiro-2″-norbornane-5,5″,6,6″-tetracarboxylic acid), and tetracarboxylic acid derivatives other than tetracarboxylic dianhydride, including tetracarboxylic acid silyl ester, tetracarboxylic acid ester and tetracarboxylic acid chloride. The derivative included in the diamine component means diamine derivatives including silylated diamine.

In addition, the norbornane-2-spiro-α-cyclopentanone-α′-spiro-2″-norbornane-5,5″,6,6″-tetracarboxylic dianhydride wherein the ratio of the peak area in the retention time 33.4-33.5 is 60% or more, preferably 65% or more, more preferably 75% or more, more preferably 78% or more, more preferably 80% or more, more preferably 90% or more, particularly preferably 95% or more, relative to the total peak area in the retention time 31.7-33.5 in a gas chromatogram obtained by conducting gas chromatography analysis under the conditions as described below, or a derivative thereof is used in the present invention.

(Gas Chromatography Analysis Conditions)

Measurement sample: Solution prepared by dissolving 0.25 g of norbornane-2-spiro-α-cyclopentanone-α′-spiro-2″-norbornane-5,5″,6,6″-tetracarboxylic
dianhydride in 5 mL of N,N-dimethylacetamide;
Column: “Rtx-5 Amine” made by SHIMADZU GLC Ltd. (length: 30 m);
Column temperature: Temperature is increased from 50° C. to 300° C. at the rate of 10° C./min, and maintained at 300° C.;

### Carrier gas: He;

Flow rate (flow rate of carrier gas): 10 mL/min;
Sample inlet temperature: 290° C.;
Detector temperature: 310° C.;
Amount of injected sample: 1 μL.

In the gas chromatogram obtained by analyzing norbornane-2-spiro-α-cyclopentanone-α′-spiro-2″-norbornane-5,5″,6,6″-tetracarboxylic dianhydride by gas chromatography under the conditions as described above, four peaks at most, specifically, peak of about 31.7-31.8 retention time, peak of about 32.0-32.1 retention time, peak of about 32.5-32.6 retention time, and peak of about 33.4-33.5 retention time are observed in the area of about 31.7-33.5 retention time. (The term “about” means variation within about ±0.1.) When norbornane-2-spiro-α-cyclopentanone-α′-spiro-2″-norbornane-5,5″,6,6″-tetracarboxylic dianhydride wherein the ratio of the peak area of about 33.4-33.5 retention time is 60% or more, preferably 65% or more, more preferably 75% or more (the ratio may be 100%) relative to the total of these peak areas, or a derivative thereof is used, a polyimide having a comparable transparency and high heat resistance, and having a lower coefficient of linear thermal expansion may be obtained. In other words, although the properties of the obtained polyimide vary according to the diamine component in combination with the tetracarboxylic acid component (norbornane-2-spiro-α-cyclopentanone-α′-spiro-2″-norbornane-5,5″,6,6″-tetracarboxylic dianhydride), when a specific norbornane-2-spiro-α-cyclopentanone-α′-spiro-2″-norbornane-5,5″,6,6″-tetracarboxylic dianhydride as described above, or a derivative thereof is used as the tetracarboxylic acid component, the coefficient of linear thermal expansion up to a high temperature of the obtained polyimide may be reduced, while maintaining the excellent properties other than the coefficient of linear thermal expansion, for example, high transparency and high heat resistance, and therefore a polyimide having excellent properties such as high transparency and high heat resistance, and having a very low coefficient of linear thermal expansion up to a high temperature may be obtained, whatever diamine component is used.

Norbornane-2-spiro-α-cyclopentanone-α′-spiro-2″-norbornane-5,5″,6,6″-tetracarboxylic dianhydride includes six types of stereoisomers, that is, trans-endo-endo-norbornane-2-spiro-α-cyclopentanone-α′-spiro-2″-norbornane-5,5″,6,6″-tetracarboxylic dianhydride (CpODAt-en-en), cis-endo-endo-norbornane-2-spiro-α-cyclopentanone-α′-spiro-2″-norbornane-5,5″,6,6″-tetracarboxylic dianhydride (CpODAc-en-en), trans-exo-endo-norbornane-2-spiro-α-cyclopentanone-α′-spiro-2″-norbornane-5,5″,6,6″-tetracarboxylic dianhydride (CpODAt-ex-en), trans-exo-exo-norbornane-2-spiro-α-cyclopentanone-α′-spiro-2″-norbornane-5,5″,6,6″-tetracarboxylic dianhydride (CpODAt-ex-ex), cis-exo-endo-norbornane-2-spiro-α-cyclopentanone-α′-spiro-2″-norbornane-5,5″,6,6″-tetracarboxylic dianhydride (CpODAc-ex-en), and cis-exo-exo-norbornane-2-spiro-α-cyclopentanone-α′-spiro-2″-norbornane-5,5″,6,6″-tetracarboxylic dianhydride (CpODAc-ex-ex). It is assumed that each of four peaks in the gas chromatogram is attributed to one, or two or more types out of the six types of stereoisomers.

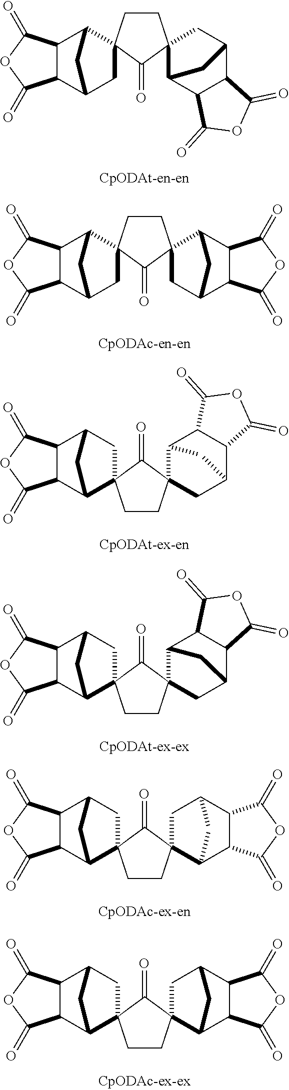

The polyimide precursor of the present invention comprises at least one repeating unit represented by the chemical formula (1), for example, as the repeating unit derived from norbornane-2-spiro-α-cyclopentanone-α′-spiro-2″-norbornane-5,5″,6,6″-tetracarboxylic dianhydride or a derivative thereof, and a diamine or a derivative thereof. The chemical formula (1), however, indicates that in two norbornane rings (bicyclo[2.2.1]heptane), the acid group in either 5-position or 6-position reacts with an amino group to form an amide bond (—CONH—) and the other is a group represented by the formula: —COOX₁ or a group represented by the formula: —COOX₂, both of which do not form an amide bond. The chemical formula (1) includes all of the four structural isomers, that is,

(i) the one having a group represented by the formula: —COOX₁ in the 5-position and a group represented by the formula: —CONH— in the 6-position, and having a group represented by the formula: —COOX₂ in the 5″-position and a group represented by the formula: —CONH-A- in the 6″-position;

(ii) the one having a group represented by the formula: —COOX₁ in the 6-position and a group represented by the formula: —CONH— in the 5-position, and having a group represented by the formula: —COOX₂ in the 5″-position and a group represented by the formula: —CONH-A- in the 6″-position;

(iii) the one having a group represented by the formula: —COOX₁ in the 5-position and a group represented by the formula: —CONH— in the 6-position, and having a group represented by the formula: —COOX₂ in the 6″-position and a group represented by the formula: —CONH-A- in the 5″-position; and

(iv) the one having a group represented by the formula: —COOX₁ in the 6-position and a group represented by the formula: —CONH— in the 5-position, and having a group represented by the formula: —COOX₂ in the 6″-position and a group represented by the formula: —CONH-A- in the 5″-position. The polyimide precursor is a polyimide precursor obtained from

a tetracarboxylic acid component comprising norbornane-2-spiro-α-cyclopentanone-α′-spiro-2″-norbornane-5,5″,6,6″-tetracarboxylic dianhydride as described above, or a derivative thereof (norbornane-2-spiro-α-cyclopentanone-α′-spiro-2″-norbornane-5,5″,6,6″-tetracarboxylic acid, and silyl ester thereof, ester thereof, chloride thereof, and the like) and

a diamine component comprising an aromatic diamine or an aliphatic diamine, preferably an aromatic diamine, or a derivative thereof (silylated diamine, and the like).

As the tetracarboxylic acid component to provide a repeating unit of the chemical formula (1), norbornane-2-spiro-α-cyclopentanone-α′-spiro-2″-norbornane-5,5″,6,6″-tetracarboxylic dianhydride as described above, and derivatives thereof may be used alone or in combination of a plurality of types.

As the diamine component to provide a repeating unit of the chemical formula (1), aromatic diamines which provide the one in which A is a group represented by the chemical formula (2), and derivatives thereof may be used, and other aromatic or aliphatic diamines other than these diamines, and derivatives thereof may also be used.

The diamine component to provide a repeating unit of the chemical formula (1) in which A is a structure of the chemical formula (2) has an aromatic ring, and when the diamine component has a plurality of aromatic rings, the aromatic rings are each independently linked to each other by direct bond, amide bond, or ester bond. When the aromatic rings are linked at the 4-position relative to the amino group or the linking group between the aromatic rings, the obtained polyimide has a linear structure and may have low linear thermal expansibility, although the linking position of the aromatic rings is not limited thereto. Meanwhile, the aromatic ring may be substituted by methyl or trifluoromethyl. The substitution position is not particularly limited.

Examples of the diamine component to provide a repeating unit of the chemical formula (1) in which A is a structure of the chemical formula (2) include, but not limited to, p-phenylenediamine, m-phenylenediamine, benzidine, 3,3′-diamino-biphenyl, 2,2′-bis(trifluoromethyl)benzidine, 3,3′-bis(trifluoromethyl)benzidine, m-tolidine, 4,4′-diaminobenzanilide, 3,4′-diaminobenzanilide, N,N′-bis(4-aminophenyl)terephthalamide, N,N′-p-phenylene bis(p-aminobenzamide), 4-aminophenoxy-4-diaminobenzoate, bis(4-aminophenyl)terephthalate, biphenyl-4,4′-dicarboxylic acid bis(4-aminophenyl)ester, p-phenylene bis(p-aminobenzoate), bis(4-aminophenyl)-[1,1′-biphenyl]-4,4′-dicarboxylate, and [1,1′-biphenyl]-4,4′-diyl bis(4-aminobenzoate). The diamine component may be used alone or in combination of a plurality of types. Among them, p-phenylenediamine, m-tolidine, 4,4′-diaminobenzanilide, 4-aminophenoxy-4-diaminobenzoate, 2,2′-bis(trifluoromethyl)benzidine, benzidine, N,N′-bis(4-aminophenyl) terephthalamide, and biphenyl-4,4′-dicarboxylic acid bis(4-aminophenyl)ester are preferred, and p-phenylenediamine, 4,4′-diaminobenzanilide, and 2,2′-bis(trifluoromethyl)benzidine are more preferred.

When p-phenylenediamine, 4,4′-diaminobenzanilide, or 2,2′-bis(trifluoromethyl)benzidine is used as the diamine component, the obtained polyimide may combine high heat resistance and high light transmittance. These diamines may be used alone or in combination of a plurality of types. Meanwhile, o-tolidine is not preferred because it is highly hazardous.

As the diamine component to provide a repeating unit of the chemical formula (1), other diamines other than the diamine component which provides the one in which A is a structure of the chemical formula (2) may be used in combination therewith. As the other diamine component, other aromatic or aliphatic diamines may be used. Examples of the other diamine component include 4,4′-oxydianiline, 3,4′-oxydianiline, 3,3′-oxydianiline, p-methylene bis(phenylenediamine), 1, 3-bis(4-aminophenoxy)benzene, 1,3-bis(3-aminophenoxy)benzene, 1,4-bis(4-aminophenoxy)benzene, 2,2-bis[4-(4-aminophenoxy)phenyl]hexafluoropropane, 2,2-bis(4-aminophenyl) hexafluoropropane, bis(4-aminophenyl)sulfone, 3,3-bis((aminophenoxy) phenyl)propane, 2,2-bis(3-amino-4-hydroxyphenyl)hexafluoropropane, bis(4-(4-aminophenoxy)diphenyl)sulfone, bis(4-(3-aminophenoxy)diphenyl)sulfone, octafluorobenzidine, 3,3′-dimethoxy-4,4′-diaminobiphenyl, 3,3′-dichloro-4,4′-diaminobiphenyl, 3,3′-difluoro-4,4′-diaminobiphenyl, 9,9-bis(4-aminophenyl) fluorene, 4,4′-bis(4-aminophenoxy)biphenyl, 4,4′-bis(3-aminophenoxy) biphenyl, 1,4-diaminocyclohexane, 1,4-diamino-2-methylcyclohexane, 1,4-diamino-2-ethylcyclohexane, 1,4-diamino-2-n-propylcyclohexane, 1,4-diamino-2-isopropylcyclohexane, 1,4-diamino-2-n-butylcyclohexane, 1,4-diamino-2-isobutylcyclohexane, 1,4-diamino-2-sec-butylcyclohexane, 1,4-diamino-2-tert-butylcyclohexane, 1,2-diaminocyclohexane, and 1,4-diaminocyclohexane, and derivatives thereof. These may be used alone or in combination of a plurality of types.

The polyimide precursor of the present invention preferably comprises at least one repeating unit of the chemical formula (1) in which A is a group represented by the chemical formula (2). In other words, the diamine component to provide a repeating unit of the chemical formula (1) preferably comprises a diamine component to provide a repeating unit of the chemical formula (1) in which A is a structure of the chemical formula (2). When the diamine component to provide A in the chemical formula (1) is a diamine component to provide a structure of the chemical formula (2), the heat resistance of the obtained polyimide may be improved.

As for the polyimide precursor of the present invention, the ratio of the diamine component to provide a structure of the chemical formula (2) may be preferably 50 mol % or more, more preferably 70 mol % or more, more preferably 80 mol % or more, further preferably 90 mol % or more, particularly preferably 100 mol %, in total, relative to 100 mol % of the diamine component to provide A in the chemical formula (1). In other words, the ratio of one or more repeating units of the chemical formula (1) in which A is a structure of the chemical formula (2) is preferably 50 mol % or more, more preferably 70 mol % or more, more preferably 80 mol % or more, further preferably 90 mol % or more, particularly preferably 100 mol %, in total, relative to the total repeating units represented by the chemical formula (1). When the ratio of the diamine component to provide a structure of the chemical formula (2) is less than 50 mol %, the coefficient of linear thermal expansion of the obtained polyimide may be greater. In one embodiment, in view of the mechanical properties of the obtained polyimide, the ratio of the diamine component to provide a structure of the chemical formula (2) may be preferably 80 mol % or less, more preferably 90 mol % or less, or less than 90 mol %, in total, relative to 100 mol % of the diamine component to provide A in the chemical formula (1). For example, other aromatic or aliphatic diamines such as 4,4′-oxydianiline may be used preferably in an amount of less than 20 mol %, more preferably not more than 10 mol %, more preferably less than 10 mol %, relative to 100 mol % of the diamine component to provide a repeating unit of the chemical formula (1). Additionally, other aromatic or aliphatic diamines may be used in an amount of not more than 30 mol % relative to 100 mol % of the diamine component to provide a repeating unit of the chemical formula (1).

In one embodiment, the polyimide precursor of the present invention preferably comprises at least two types of repeating units of the chemical formula (1) in which A is a group represented by the chemical formula (2). In other words, the diamine component to provide a repeating unit of the chemical formula (1) preferably comprises at least two types of diamine components to provide a repeating unit of the chemical formula (1) in which A is a structure of the chemical formula (2). When the diamine component to provide A in the chemical formula (1) comprises at least two types of diamine components to provide a structure of the chemical formula (2), the balance between high transparency and low linear thermal expansibility of the obtained polyimide may be achieved (that is, a polyimide having high transparency and low coefficient of linear thermal expansion may be obtained).

In this embodiment, the polyimide precursor of the present invention more preferably comprises

(i) at least one type of repeating unit (1-1) of the chemical formula (1) in which A is a structure of the chemical formula (2) in which m₁ and/or n₁ is 1 to 3; and Z₁ and/or W₁ each independently is —NHCO—, —CONH—, —COO— or —OCO—, and

(ii) at least one type of repeating unit (1-2) of the chemical formula (1) in which A is a structure of the chemical formula (2) in which m₁ and n₁ are 0, or a structure of the chemical formula (2) in which m₁ and/or n₁ is 1 to 3; and Z₁ and W₁ are direct bond.

As the repeating unit (1-1), a repeating unit of the chemical formula (1) in which A is a group represented by any one of the chemical formulas (D-1) to (D-3) as described below is preferred, and a repeating unit of the chemical formula (1) in which A is a group represented by any one of the chemical formulas (D-1) to (D-2) as described below is more preferred. The diamine component to provide a repeating unit of the chemical formula (1) in which A is a group represented by the chemical formula (D-1) as described below or the chemical formula (D-2) as described below is 4,4′-diaminobenzanilide, and the diamine component to provide a repeating unit of the chemical formula (1) in which A is a group represented by the chemical formula (D-3) as described below is bis(4-aminophenyl)terephthalate. These diamines may be used alone or in combination of a plurality of types.

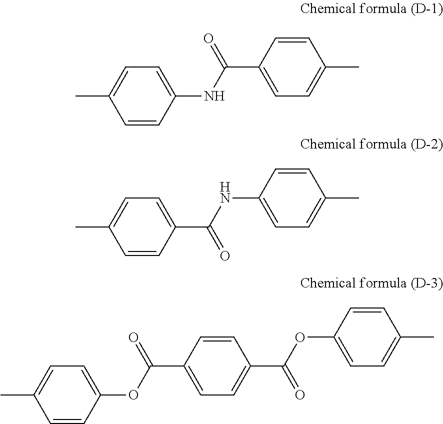

As the repeating unit (1-2), a repeating unit of the chemical formula (1) in which A is a group represented by any one of the chemical formulas (D-4) to (D-6) as described below is preferred, and a repeating unit of the chemical formula (1) in which A is a group represented by any one of the chemical formulas (D-4) to (D-5) as described below is more preferred. The diamine component to provide a repeating unit of the chemical formula (1) in which A is a group represented by the chemical formula (D-4) as described below is p-phenylenediamine, and the diamine component to provide a repeating unit of the chemical formula (1) in which A is a group represented by the chemical formula (D-5) as described below is 2,2′-bis(trifluoromethyl)benzidine, and the diamine component to provide a repeating unit of the chemical formula (1) in which A is a group represented by the chemical formula (D-6) as described below is m-tolidine. These diamines may be used alone or in combination of a plurality of types.

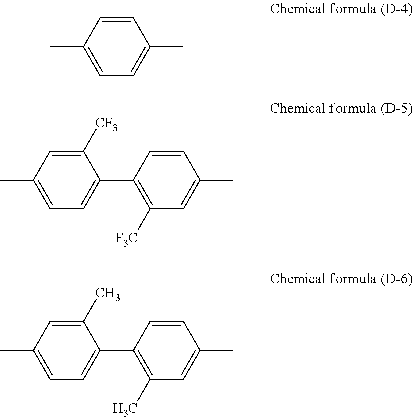

In this embodiment, it is preferred that, in the polyimide precursor of the present invention, the ratio of one or more repeating units (1-1) is 30 mol % or more and 70 mol % or less in total relative to the total repeating units represented by the chemical formula (1), and the ratio of one or more repeating units (1-2) is 30 mol % or more and 70 mol % or less in total relative to the total repeating units represented by the chemical formula (1). It is particularly preferred that the ratio of one or more repeating units (1-1) is 40 mol % or more and 60 mol % or less in total relative to the total repeating units represented by the chemical formula (1), and the ratio of one or more repeating units (1-2) is 40 mol % or more and 60 mol % or less in total relative to the total repeating units represented by the chemical formula (1). In one embodiment, the ratio of the repeating unit (1-1) is more preferably less than 60 mol %, more preferably not more than 50 mol %, particularly preferably not more than 40 mol %, in total, relative to the total repeating units represented by the chemical formula (1). Additionally, in one embodiment, the polyimide precursor may preferably comprise other repeating units represented by the chemical formula (1) other than the repeating unit (1-1) and the repeating unit (1-2) (for example, the one in which A has a plurality of aromatic rings and the aromatic rings are linked to each other by ether bond (—O—)) in an amount of not more than 30 mol %, preferably less than 20 mol %, more preferably not more than 10 mol %, particularly preferably less than 10 mol %, relative to the total repeating units represented by the chemical formula (1).

In one embodiment, the diamine component to provide A in the chemical formula (1) (diamine component to provide a repeating unit of the chemical formula (1)) preferably comprises at least two types of diamine components to provide a structure of the chemical formula (2), one of which is 4,4′-diaminobenzanilide, in the polyimide precursor of the present invention. When the diamine component to provide A in the chemical formula (1) comprises at least two types of diamine components to provide a structure of the chemical formula (2), one of which is 4,4′-diaminobenzanilide, a polyimide having high heat resistance in addition to high transparency and low linear thermal expansibility may be obtained.

In one embodiment, the diamine component to provide A in the chemical formula (1) (diamine component to provide a repeating unit of the chemical formula (1)) particularly preferably comprises at least one selected from 2,2′-bis(trifluoromethyl)benzidine and p-phenylenediamine, and 4,4′-diaminobenzanilide in the polyimide precursor of the present invention. When these diamine components are combined together, a polyimide having high transparency and low linear thermal expansibility, and high heat resistance may be obtained.

In this embodiment, the diamine component to provide A in the chemical formula (1) (diamine component to provide a repeating unit of the chemical formula (1)) preferably comprises 4,4′-diaminobenzanilide in an amount of 30 mol % or more and 70 mol % or less, and either one or both of p-phenylenediamine and 2,2′-bis(trifluoromethyl)benzidine in an amount of 30 mol % or more and 70 mol % or less, and particularly preferably comprises 4,4′-diaminobenzanilide in an amount of 40 mol % or more and 60 mol % or less, and either one or both of p-phenylenediamine and 2,2′-bis(trifluoromethyl)benzidine in an amount of 40 mol % or more and 60 mol % or less. When the diamine component to provide A in the chemical formula (1) comprises 4,4′-diaminobenzanilide in an amount of 30 mol % or more and 70 mol % or less, and either one or both of p-phenylenediamine and 2,2′-bis(trifluoromethyl)benzidine in an amount of 30 mol % or more and 70 mol % or less, a polyimide having high transparency and low linear thermal expansibility, and high heat resistance may be obtained. In one embodiment, the diamine component to provide A in the chemical formula (1) (diamine component to provide a repeating unit of the chemical formula (1)) more preferably comprises 4,4′-diaminobenzanilide in an amount of less than 60 mol %, more preferably not more than 50 mol %, particularly preferably not more than 40 mol %.

In one embodiment, it may be preferred that the polyimide precursor of the present invention comprises one or more of repeating unit (1-1) as described above [repeating unit (1-1) of the chemical formula (1) in which A is a structure of the chemical formula (2) in which m₁ and/or n₁ is 1 to 3; and Z₁ and/or W₁ each independently is —NHCO—, —CONH—, —COO— or —OCO—], for example, repeating unit of the chemical formula (1) in which A is a group represented by any one of the chemical formulas (D-1) to (D-3), and does not comprise a repeating unit (1-2) as described above [repeating unit (1-2) of the chemical formula (1) in which A is a structure of the chemical formula (2) in which m₁ and n₁ are 0, or a structure of the chemical formula (2) in which m₁ and/or n₁ is 1 to 3; and Z₁ and W₁ are direct bond], or alternatively, the polyimide precursor of the present invention comprises one or more of repeating unit (1-2) as described above [repeating unit (1-2) of the chemical formula (1) in which A is a structure of the chemical formula (2) in which m₁ and n₁ are 0, or a structure of the chemical formula (2) in which m₁ and/or n₁ is 1 to 3; and Z₁ and W₁ are direct bond], for example, repeating unit of the chemical formula (1) in which A is a group represented by any one of the chemical formulas (D-4) to (D-6), and does not comprise a repeating unit (1-1) as described above [repeating unit (1-1) of the chemical formula (1) in which A is a structure of the chemical formula (2) in which m₁ and/or n₁ is 1 to 3; and Z₁ and/or W₁ each independently is —NHCO—, —CONH—, —COO— or —OCO—].

The polyimide precursor of the present invention may comprise other repeating units other than the repeating unit represented by the chemical formula (1). Other aromatic or aliphatic tetracarboxylic acids, or the like may be used as the tetracarboxylic acid component to provide the other repeating unit. Examples thereof include derivatives of, and dianhydrides of 2,2-bis(3,4-dicarboxyphenyl)hexafluoropropane, 4-(2, 5-dioxotetrahydrofuran-3-yl)-1,2, 3, 4-tetrahydronaphthalene-1,2-dicarboxylic acid, pyromellitic acid, 3,3′,4,4′-benzophenone tetracarboxylic acid, 3,3′,4,4′-biphenyl tetracarboxylic acid, 2,3,3′,4′-biphenyl tetracarboxylic acid, 4,4′-oxydiphthalic acid, bis(3,4-dicarboxyphenyl)sulfone dianhydride, m-terphenyl-3,4,3′,4′-tetracarboxylic dianhydride, p-terphenyl-3,4,3′,4′-tetracarboxylic dianhydride, biscarboxyphenyl dimethylsilane, bis dicarboxy phenoxy diphenyl sulfide, sulfonyl diphthalic acid, 1,2,3,4-cyclobutane tetracarboxylic acid, isopropylidene diphenoxy bis phthalic acid, cyclohexane-1,2,4, 5-tetracarboxylic acid, [1,1′-bi(cyclohexane)]-3,3′,4,4′-tetracarboxylic acid, [1,1′-bi(cyclohexane)]-2,3,3′,4′-tetracarboxylic acid, [1,1′-bi(cyclohexane)]-2,2′,3,3′-tetracarboxylic acid, 4,4′-methylene bis(cyclohexane-1,2-dicarboxylic acid), 4,4′-(propane-2,2-diyl)bis(cyclohexane-1,2-dicarboxylic acid), 4,4′-oxy bis(cyclohexane-1,2-dicarboxylic acid), 4,4′-thio bis(cyclohexane-1,2-dicarboxylic acid), 4,4′-sulfonyl bis(cyclohexane-1,2-dicarboxylic acid), 4,4′-(dimethylsilanediyl)bis(cyclohexane-1,2-dicarboxylic acid), 4,4′-(tetrafluoropropane-2,2-diyl)bis(cyclohexane-1,2-dicarboxylic acid), octahydropentalene-1,3,4, 6-tetracarboxylic acid, bicyclo[2.2.1]heptane-2,3,5,6-tetracarboxylic acid, 6-(carboxymethyl)bicyclo[2.2.1]heptane-2, 3,5-tricarboxylic acid, bicyclo[2.2.2]octane-2,3,5,6-tetracarboxylic acid, bicyclo[2.2.2]octa-5-ene-2,3,7,8-tetracarboxylic acid, tricyclo[4.2.2.02,5]decane-3,4,7,8-tetracarboxylic acid, tricyclo[4.2.2.02,5]deca-7-ene-3,4,9,10-tetracarboxylic acid, 9-oxatricyclo[4.2.1.02,5]nonane-3,4,7,8-tetracarboxylic acid, (4arH, 8acH)-decahydro-1t, 4t:5c, 8c-dimethanonaphthalene-2c,3c,6c,7c-tetracarboxylic acid, and (4arH,8acH)-decahydro-1t,4t:5c,8c-dimethanonaphthalene-2t,3t,6c,7c-tetracarboxylic acid, and the like. These may be used alone or in combination of a plurality of types. Among them, derivatives and dianhydrides of bicyclo[2.2.1]heptane-2,3,5,6-tetracarboxylic acid, bicyclo[2.2.2]octane-2,3,5,6-tetracarboxylic acid, (4arH,8acH)-decahydro-It, 4t:5c, 8c-dimethanonaphthalene-2c,3c,6c,7c-tetracarboxylic acid, and (4arH,8acH)-decahydro-1t,4t:5c,8c-dimethanonaphthalene-2t,3t,6c,7c-tetracarboxylic acid, and the like are more preferred, because the polyimide is easily produced, and the obtained polyimide has excellent heat resistance. These dianhydrides may be used alone or in combination of a plurality of types.

In the polyimide precursor of the present invention, the diamine component to provide the other repeating unit other than the repeating unit represented by the chemical formula (1) may be any one of the diamine components to provide a structure of the chemical formula (2). In other words, the aromatic diamines described as the diamine component to provide a repeating unit of the chemical formula (1) in which A is a structure of the chemical formula (2) may be used as the diamine component to provide the other repeating unit other than the repeating unit represented by the chemical formula (1). These diamines may be used alone or in combination of a plurality of types.

In the polyimide precursor of the present invention, other aromatic or aliphatic diamines may be used as the diamine component to provide the other repeating unit other than the repeating unit represented by the chemical formula (1). Examples thereof include 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 2,2-bis[4-(4-aminophenoxy)phenyl]hexafluoropropane, 2,2-bis(4-aminophenyl)hexafluoropropane, bis(4-aminophenyl)sulfone, 3,3-bis((aminophenoxy)phenyl)propane, 2,2-bis(3-amino-4-hydroxyphenyl)hexafluoropropane, bis(4-(4-aminophenoxy)diphenyl)sulfone, bis(4-(3-aminophenoxy)diphenyl)sulfone, octafluorobenzidine, 3,3′-dimethoxy-4,4′-diaminobiphenyl, 3,3′-dichloro-4,4′-diaminobiphenyl, 3,3′-difluoro-4,4′-diaminobiphenyl, 9,9-bis(4-aminophenyl) fluorene, 4,4′-bis(4-aminophenoxy)biphenyl, 4,4′-bis(3-aminophenoxy) biphenyl, 1,4-diaminocyclohexane, 1,4-diamino-2-methylcyclohexane, 1,4-diamino-2-ethylcyclohexane, 1,4-diamino-2-n-propylcyclohexane, 1,4-diamino-2-isopropylcyclohexane, 1,4-diamino-2-n-butylcyclohexane, 1,4-diamino-2-isobutylcyclohexane, 1,4-diamino-2-sec-butylcyclohexane, 1,4-diamino-2-tert-butylcyclohexane, 1,2-diaminocyclohexane, and 1,4-diaminocyclohexane, and derivatives thereof. These may be used alone or in combination of a plurality of types.

In the polyimide precursor of the present invention, the ratio of other repeating units other than the repeating unit represented by the chemical formula (1) is preferably 30 mol % or less, more preferably 10 mol % or less, more preferably less than 10 mol %, in total, relative to the total repeating units. In other words, the tetracarboxylic acid component may preferably comprise a tetracarboxylic acid component to provide a repeating unit represented by the chemical formula (1) (that is, norbornane-2-spiro-α-cyclopentanone-α′-spiro-2″-norbornane-5,5″,6,6″-tetracarboxylic dianhydride, and derivatives thereof) in an amount of 70 mol % or more, more preferably 90 mol % or more, more preferably more than 90 mol %, and other tetracarboxylic acid components in an amount of 30 mol % or less, more preferably 10 mol % or less, more preferably less than 10 mol %, relative to 100 mol % of the total tetracarboxylic acid components.

The tetracarboxylic acid component includes tetracarboxylic acid, and tetracarboxylic acid derivatives including tetracarboxylic dianhydride, tetracarboxylic acid silyl ester, tetracarboxylic acid ester and tetracarboxylic acid chloride.

Norbornane-2-spiro-α-cyclopentanone-α′-spiro-2″-norbornane-5,5″,6,6″-tetracarboxylic dianhydride, or the like may be synthesized by the method described in Patent Literature 6, or the like, although the method for synthesizing norbornane-2-spiro-α-cyclopentanone-α′-spiro-2″-norbornane-5,5″,6,6″-tetracarboxylic dianhydride, or the like is not limited thereto. As described in Non Patent Literature 1, norbornane-2-spiro-α-cyclopentanone-α′-spiro-2″-norbornane-5,5″,6,6″-tetracarboxylic dianhydride, or the like may comprise several types of stereoisomers, which depends on the synthesis method.

Although the methods for synthesizing derivatives of norbornane-2-spiro-α-cyclopentanone-α′-spiro-2″-norbornane-5,5″,6,6″-tetracarboxylic acid are not limited thereto, to give an example, the tetracarboxylic acid ester may be synthesized by the method described in Patent Literature 6, or the like. The tetracarboxylic acid may be obtained by hydrolyzing the tetracarboxylic acid ester with a base catalyst such as sodium hydroxide or an acid catalyst such as hydrochloric acid. The tetracarboxylic acid silyl ester may be obtained by reacting the tetracarboxylic acid and a silylating agent. Examples of the silylating agent include N,O-bis(trimethylsilyl) trifluoroacetamide, N,O-bis(trimethylsilyl)acetamide, hexamethyldisilazane, and trimethylchlorosilane. The tetracarboxylic acid chloride may be obtained by reacting the tetracarboxylic acid and a chlorinating agent. Examples of the chlorinating agent include thionyl chloride, and oxalyl chloride.

Norbornane-2-spiro-α-cyclopentanone-α′-spiro-2″-norbornane-5,5″,6,6″-tetracarboxylic dianhydride, or the like, or an intermediate thereof may be subjected to purification by the use of column, or the like to isolate each one of stereoisomers, or a mixture of two or more types of stereoisomers.

Single products of, or a mixture of stereoisomers such as trans-endo-endo-norbornane-2-spiro-α-cyclopentanone-α′-spiro-2″-norbornane-5,5″,6,6″-tetracarboxylic dianhydride, or the like, and cis-endo-endo-norbornane-2-spiro-α-cyclopentanone-α′-spiro-2″-norbornane-5,5″,6,6″-tetracarboxylic dianhydride, or the like may be obtained by subjecting norbornane-2-spiro-α-cyclopentanone-α′-spiro-2″-norbornane-5,5″,6,6″-tetracarboxylic dianhydride, or the like, or an intermediate thereof to purification by the use of column, or the like.

As for the polyimide precursor of the present invention, when the tetracarboxylic acid component and the diamine component comprise isomers, each one of the isomers may be isolated and used for the polymerization, or the like, or alternatively, the isomers as the mixture may be used for the polymerization, or the like. However, the norbornane-2-spiro-α-cyclopentanone-α′-spiro-2″-norbornane-5,5″,6,6″-tetracarboxylic dianhydride which is the tetracarboxylic acid component to be used in the present invention is the one in which the ratio of the peak area in the retention time of about 33.4-33.5 is 60% or more relative to the total peak area in the retention time of about 31.7-33.5 in a gas chromatogram obtained by conducting gas chromatography analysis under the conditions as described above.

In the polyimide precursor of the present invention, X₁ and X₂ in the chemical formula (1) are each independently hydrogen, an alkyl group having 1 to 6 carbon atoms, preferably having 1 to 3 carbon atoms, or an alkylsilyl group having 3 to 9 carbon atoms. As for X₁ and X₂, the types of the functional groups and the introduction ratio of the functional groups may be changed by the production method as described later.

In the case where X₁ and X₂ are hydrogen, a polyimide tends to be easily produced therefrom.

Meanwhile, in the case where X₁ and X₂ are alkyl group having 1 to 6 carbon atoms, preferably having 1 to 3 carbon atoms, the polyimide precursor tends to have excellent storage stability. In this case, X₁ and X₂ are more preferably methyl or ethyl.

Additionally, in the case where X₁ and X₂ are alkylsilyl group having 3 to 9 carbon atoms, the polyimide precursor tends to have excellent solubility. In this case, X₁ and X₂ are more preferably trimethylsilyl or t-butyldimethylsilyl.

When an alkyl group or an alkylsilyl group is introduced, X₁ and X₂ each may be converted into an alkyl group or an alkylsilyl group in a ratio of 25% or more, preferably 50% or more, more preferably 75% or more, although the introduction ratio of the functional groups is not limited thereto. When X₁ and X₂ each are converted into an alkyl group or an alkylsilyl group in a ratio of 25% or more, the polyimide precursor may have excellent storage stability.

According to the chemical structures which X₁ and X₂ have, the polyimide precursors of the present invention may be each independently classified into

1) polyamic acid (X₁ and X₂ are hydrogen),

2) polyamic acid ester (at least part of X₁ and X₂ is alkyl group), and

3) 4) polyamic acid silyl ester (at least part of X₁ and X₂ is alkylsilyl group).

Each class of the polyimide precursors of the present invention may be easily produced by the production methods as described below. However, the method for producing the polyimide precursor of the present invention is not limited to the production methods as described below.

1) Polyamic Acid

The polyimide precursor of the present invention may be suitably obtained, in the form of a polyimide precursor solution composition, by reacting a tetracarboxylic dianhydride as a tetracarboxylic acid component and a diamine component in a substantially equimolar amount, preferably in a molar ratio of the diamine component to the tetracarboxylic acid component [molar number of the diamine component/molar number of the tetracarboxylic acid component] of 0.90 to 1.10, more preferably 0.95 to 1.05, in a solvent at a relatively low temperature of 120° C. or less, for example, to suppress the imidization.

More specifically, the polyimide precursor may be obtained by dissolving the diamine in an organic solvent, adding the tetracarboxylic dianhydride to the resulting solution gradually while stirring the solution, and then stirring the solution at a temperature of 0° C. to 120° C., preferably 5° C. to 80° C., for 1 hour to 72 hours, although the method for synthesizing the polyimide precursor of the present invention is not limited thereto. When they are reacted at a temperature of 80° C. or more, the molecular weight may vary depending on the temperature history in the polymerization and the imidization may proceed by heat, and therefore the polyimide precursor may not be stably produced. The sequence of the addition of the diamine and the tetracarboxylic dianhydride in the production method as described above is preferred because the molecular weight of the polyimide precursor is apt to increase. Meanwhile, the sequence of the addition of the diamine and the tetracarboxylic dianhydride in the production method as described above may be reversed, and the sequence is preferred because the amount of the precipitate is reduced.

In addition, when the diamine component is excessive in the molar ratio of the tetracarboxylic acid component to the diamine component, a carboxylic acid derivative may be added in an amount which substantially corresponds to the excessive molar number of the diamine component, as necessary, so that the molar ratio of the tetracarboxylic acid component to the diamine component is closer to the substantially equimolar amount. As the carboxylic acid derivative to be used herein, tetracarboxylic acids, which do not substantially increase the viscosity of the polyimide precursor solution, that is, do not substantially involve the molecular chain extension, or tricarboxylic acids and anhydrides thereof, and dicarboxylic acids and anhydrides thereof, which function as an end-stopping agent, and the like are preferred.

2) Polyamic Acid Ester

A diester dicarboxylic acid chloride may be obtained by reacting a tetracarboxylic dianhydride and an arbitrary alcohol to provide a diester dicarboxylic acid, and then reacting the diester dicarboxylic acid and a chlorinating agent (thionyl chloride, oxalyl chloride, and the like). The polyimide precursor may be obtained by stirring the diester dicarboxylic acid chloride and a diamine at a temperature of −20° C. to 120° C., preferably −5° C. to 80° C., for 1 hour to 72 hours. When they are reacted at a temperature of 80° C. or more, the molecular weight may vary depending on the temperature history in the polymerization and the imidization may proceed by heat, and therefore the polyimide precursor may not be stably produced. The polyimide precursor may also be easily obtained by dehydrating/condensing a diester dicarboxylic acid and a diamine by the use of a phosphorus-based condensing agent, a carbodiimide condensing agent, or the like.

The polyimide precursor obtained by the method is stable, and therefore the polyimide precursor may be subjected to purification, for example, reprecipitation in which a solvent such as water and alcohols is added thereto.

3) Polyamic Acid Silyl Ester (Indirect Method)

A silylated diamine may be obtained by reacting a diamine and a silylating agent in advance. The silylated diamine may be purified by distillation, or the like, as necessary. And then, the polyimide precursor may be obtained by dissolving the silylated diamine in a dehydrated solvent, adding a tetracarboxylic dianhydride to the resulting solution gradually while stirring the solution, and then stirring the solution at a temperature of 0° C. to 120° C., preferably 5° C. to 80° C., for 1 hour to 72 hours. When they are reacted at a temperature of 80° C. or more, the molecular weight may vary depending on the temperature history in the polymerization and the imidization may proceed by heat, and therefore the polyimide precursor may not be stably produced.

As for the silylating agent to be used herein, the use of a silylating agent containing no chlorine is preferred because it is unnecessary to purify the silylated diamine. Examples of the silylating agent containing no chlorine atom include N,O-bis(trimethylsilyl)trifluoroacetamide, N,O-bis(trimethylsilyl)acetamide, and hexamethyldisilazane. Among them, N, O-bis(trimethylsilyl)acetamide, and hexamethyldisilazane are particularly preferred, because they contain no fluorine atom and are inexpensive.

In addition, in the silylation reaction of diamine, an amine catalyst such as pyridine, piperidine and triethylamine may be used so as to accelerate the reaction. The catalyst may be used, as it is, as a catalyst for the polymerization of the polyimide precursor.

4) Polyamic Acid Silyl Ester (Direct Method)

The polyimide precursor may be obtained by mixing a polyamic acid solution obtained by the method 1) and a silylating agent, and then stirring the resulting mixture at a temperature of 0° C. to 120° C., preferably 5° C. to 80° C., for 1 hour to 72 hours. When they are reacted at a temperature of 80° C. or more, the molecular weight may vary depending on the temperature history in the polymerization and the imidization may proceed by heat, and therefore the polyimide precursor may not be stably produced.

As for the silylating agent to be used herein, the use of a silylating agent containing no chlorine is preferred because it is unnecessary to purify the silylated polyamic acid, or the obtained polyimide. Examples of the silylating agent containing no chlorine atom include N, O-bis(trimethylsilyl) trifluoroacetamide, N, O-bis(trimethylsilyl)acetamide, and hexamethyldisilazane. Among them, N,O-bis(trimethylsilyl)acetamide, and hexamethyldisilazane are particularly preferred, because they contain no fluorine atom and are inexpensive.

All of the production methods as described above may be suitably performed in an organic solvent, and as a consequence thereof, a varnish of the polyimide precursor of the present invention may be easily obtained.

As the solvent used in the production of the polyimide precursor, for example, aprotic solvents such as N, N-dimethylformamide, N, N-dimethylacetamide, N-methyl-2-pyrrolidone, 1,3-dimethyl-2-imidazolidinone and dimethyl sulfoxide are preferred, and N, N-dimethylacetamide and N-methyl-2-pyrrolidone are particularly preferred. However, any solvent may be used without any trouble on the condition that the starting monomer components and the formed polyimide precursor can be dissolved in the solvent, and the structure of the solvent is not limited thereto. Examples of the solvent preferably employed include amide solvents such as N, N-dimethylformamide, N, N-dimethylacetamide and N-methylpyrrolidone; cyclic ester solvents such as γ-butyrolactone, γ-valerolactone, δ-valerolactone, γ-caprolactone, ε-caprolactone and α-methyl-γ-butyrolactone; carbonate solvents such as ethylene carbonate and propylene carbonate; glycol solvents such as triethylene glycol; phenol solvents such as m-cresol, p-cresol, 3-chlorophenol and 4-chlorophenol; acetophenone, 1,3-dimethyl-2-imidazolidinone, sulfolane, and dimethylsulfoxide. In addition, other common organic solvents, namely, phenol, o-cresol, butyl acetate, ethyl acetate, isobutyl acetate, propyleneglycol methyl acetate, ethyl cellosolve, butyl cellosolve, 2-methyl cellosolve acetate, ethyl cellosolve acetate, butyl cellosolve acetate, tetrahydrofuran, dimethoxyethane, diethoxyethane, dibutyl ether, diethylene glycol dimethyl ether, methyl isobutyl ketone, diisobutyl ketone, cyclopentanone, cyclohexanone, methyl ethyl ketone, acetone, butanol, ethanol, xylene, toluene, chlorobenzene, turpentine, mineral spirits, petroleum naphtha-based solvents, and the like may be used. These solvents may be used in combination of a plurality of types.

In the present invention, although the logarithmic viscosity of the polyimide precursor is not limited thereto, the logarithmic viscosity of the polyimide precursor in a N,N-dimethylacetamide solution at a concentration of 0.5 g/dL at 30° C. may be preferably 0.2 dL/g or more, more preferably 0.8 dL/g or more, particularly preferably 0.9 dL/g or more. When the logarithmic viscosity is 0.2 dL/g or more, the molecular weight of the polyimide precursor is high, and therefore the obtained polyimide may have excellent mechanical strength and heat resistance.

In the present invention, it is preferred that the varnish of the polyimide precursor comprises at least the polyimide precursor of the present invention and a solvent, and the total amount of the tetracarboxylic acid component and the diamine component is 5 mass % or more, preferably 10 mass % or more, more preferably 15 mass % or more, relative to the total amount of the solvent, the tetracarboxylic acid component and the diamine component. Additionally, it is generally preferred that the total amount is 60 mass % or less, preferably 50 mass % or less. When the concentration, which is approximate to the concentration of the solid content based on the polyimide precursor, is too low, it may be difficult to control the thickness of the obtained polyimide film in the production of the polyimide film, for example.

As the solvent used for the varnish of the polyimide precursor of the present invention, any solvent may be used without any trouble on the condition that the polyimide precursor can be dissolved in the solvent, and the structure of the solvent is not particularly limited. Examples of the solvent preferably employed include amide solvents such as N, N-dimethylformamide, N, N-dimethylacetamide and N-methyl-2-pyrrolidone; cyclic ester solvents such as γ-butyrolactone, γ-valerolactone, δ-valerolactone, γ-caprolactone, ε-caprolactone and α-methyl-γ-butyrolactone; carbonate solvents such as ethylene carbonate and propylene carbonate; glycol solvents such as triethylene glycol; phenol solvents such as m-cresol, p-cresol, 3-chlorophenol and 4-chlorophenol; acetophenone, 1,3-dimethyl-2-imidazolidinone, sulfolane, and dimethylsulfoxide. In addition, other common organic solvents, namely, phenol, o-cresol, butyl acetate, ethyl acetate, isobutyl acetate, propyleneglycol methyl acetate, ethyl cellosolve, butyl cellosolve, 2-methyl cellosolve acetate, ethyl cellosolve acetate, butyl cellosolve acetate, tetrahydrofuran, dimethoxyethane, diethoxyethane, dibutyl ether, diethylene glycol dimethyl ether, methyl isobutyl ketone, diisobutyl ketone, cyclopentanone, cyclohexanone, methyl ethyl ketone, acetone, butanol, ethanol, xylene, toluene, chlorobenzene, turpentine, mineral spirits, petroleum naphtha-based solvents, and the like may be used. Additionally, these may be used in combination of a plurality of types.

In the present invention, although the viscosity (rotational viscosity) of the varnish of the polyimide precursor is not limited thereto, the rotational viscosity, which is measured with an E-type rotational viscometer at a temperature of 25° C. and at a shearing speed of 20 sec⁻¹, may be preferably 0.01 to 1000 Pa-sec, more preferably 0.1 to 100 Pa-sec. In addition, thixotropy may be imparted, as necessary. When the viscosity is within the above-mentioned range, the varnish is easy to handle during the coating or the film formation, and the varnish is less repelled and has excellent leveling property, and therefore a good film may be obtained.

As necessary, a chemical imidizing agent (an acid anhydride such as acetic anhydride, and an amine compound such as pyridine and isoquinoline), an anti-oxidizing agent, a filler, a dye, a pigment, a coupling agent such as a silane coupling agent, a primer, a flame retardant, a defoaming agent, a leveling agent, a rheology control agent (flow-promoting agent), a releasing agent, and the like may be added to the varnish of the polyimide precursor of the present invention.

As necessary, an inorganic particle such as silica may be mixed into the varnish of the polyimide precursor of the present invention. Examples of the mixing method include, but not limited to, a method in which an inorganic particle is dispersed in a polymerization solvent, and then a polyimide precursor is polymerized in the solvent; a method in which a polyimide precursor solution and an inorganic particle are mixed; a method in which a polyimide precursor solution and an inorganic particle dispersion are mixed; and a method in which an inorganic particle is added to and mixed with a polyimide precursor solution. For example, a silica particle or a silica particle dispersion may be added to the varnish of the polyimide precursor of the present invention. As for the silica particle to be added, the particle size is preferably 100 nm or less, more preferably 50 nm or less, particularly preferably 30 nm or less. When the particle size of the silica particle to be added is more than 100 nm, the polyimide may be white-turbid. Additionally, in the case where a silica particle dispersion is added to the varnish, “ORGANOSILICASOL DMAc-ST (primary particle size: 10-15 nm, dispersion solvent: N,N-dimethylacetamide) solid content: 20-21%” made by Nissan Chemical Industries, Ltd., and the like may be used, for example.

The polyimide of the present invention is obtained from

a tetracarboxylic acid component comprising norbornane-2-spiro-α-cyclopentanone-α′-spiro-2″-norbornane-5,5″,6,6″-tetracarboxylic dianhydride wherein the ratio of the peak area in the retention time 33.4-33.5 is 60% or more, preferably 65% or more, more preferably 75% or more, more preferably 78% or more, more preferably 80% or more, more preferably 90% or more, particularly preferably 95% or more, relative to the total peak area in the retention time 31.7-33.5 in a gas chromatogram obtained by conducting gas chromatography analysis under the conditions as described below, or a derivative thereof, and

a diamine component comprising a diamine, or a derivative thereof. Herein, the derivative included in the tetracarboxylic acid component means tetracarboxylic acid (norbornane-2-spiro-α-cyclopentanone-α′-spiro-2″-norbornane-5,5″,6,6″-tetracarboxylic acid), and tetracarboxylic acid derivatives other than tetracarboxylic dianhydride, including tetracarboxylic acid silyl ester, tetracarboxylic acid ester and tetracarboxylic acid chloride. The derivative included in the diamine component means diamine derivatives including silylated diamine.

(Gas Chromatography Analysis Conditions)

Measurement sample: Solution prepared by dissolving 0.25 g of norbornane-2-spiro-α-cyclopentanone-α′-spiro-2″-norbornane-5,5″,6,6″-tetracarboxylic dianhydride in 5 mL of N,N-dimethylacetamide;
Column: “Rtx-5 Amine” made by SHIMADZU GLC Ltd. (length: 30 m);
Column temperature: Temperature is increased from 50° C. to 300° C. at the rate of 10° C./min, and maintained at 300° C.;

### Carrier gas: He;

Flow rate (flow rate of carrier gas): 10 mL/min;
Sample inlet temperature: 290° C.;
Detector temperature: 310° C.;
Amount of injected sample: 1 μL.

In other words, the polyimide of the present invention may be obtained using the tetracarboxylic acid component and the diamine component used to obtain the polyimide precursor of the present invention as described above. The polyimide of the present invention may be suitably produced by the dehydration/ring closure reaction (imidization reaction) of the polyimide precursor of the present invention as described above. The imidization method is not particularly limited, and any known thermal imidization or chemical imidization method may be suitably applied.

The polyimide of the present invention comprises at least one repeating unit represented by the chemical formula (3), for example, as the repeating unit derived from norbornane-2-spiro-α-cyclopentanone-α′-spiro-2″-norbornane-5,5″,6,6″-tetracarboxylic dianhydride or a derivative thereof, and a diamine or a derivative thereof.

The polyimide of the present invention preferably comprises at least one repeating unit of the chemical formula (3) in which B is a group represented by the chemical formula (4). The chemical formula (3) corresponds to the chemical formula (1) of the polyimide precursor of the present invention, and the chemical formula (4) corresponds to the chemical formula (2) of the polyimide precursor of the present invention. The steric structure is usually maintained after the imidization, and therefore the polyimide of the present invention, which is obtained by imidizing the polyimide precursor of the present invention, has the same steric structure as the polyimide precursor of the present invention, and the repeating unit of the chemical formula (3) has the same steric structure as the repeating unit of the chemical formula (1).

Preferred examples of the form of the obtained polyimide include a film, a laminate of a polyimide film and another substrate, a coating film, a powder, a bead, a molded article, a foamed article, and a varnish.

In the present invention, although the logarithmic viscosity of the polyimide is not limited thereto, the logarithmic viscosity of the polyimide in a N,N-dimethylacetamide solution at a concentration of 0.5 g/dL at 30° C. may be preferably 0.2 dL/g or more, more preferably 0.4 dL/g or more, particularly preferably 0.5 dL/g or more. When the logarithmic viscosity is 0.2 dL/g or more, the obtained polyimide may have excellent mechanical strength and heat resistance.

In the present invention, it is preferred that the varnish of the polyimide comprises at least the polyimide of the present invention and a solvent, and the amount of the polyimide is 5 mass % or more, preferably 10 mass % or more, more preferably 15 mass % or more, particularly preferably 20 mass % or more, relative to the total amount of the solvent and the polyimide. When the concentration is too low, it may be difficult to control the thickness of the obtained polyimide film in the production of the polyimide film, for example.

As the solvent used for the varnish of the polyimide of the present invention, any solvent may be used without any trouble on the condition that the polyimide can be dissolved in the solvent, and the structure of the solvent is not particularly limited. The solvent used for the varnish of the polyimide precursor of the present invention as described above may be used likewise as the solvent.

In the present invention, although the viscosity (rotational viscosity) of the varnish of the polyimide is not limited thereto, the rotational viscosity, which is measured with an E-type rotational viscometer at a temperature of 25° C. and at a shearing speed of 20 sec⁻¹, may be preferably 0.01 to 1000 Pa-sec, more preferably 0.1 to 100 Pa-sec. In addition, thixotropy may be imparted, as necessary. When the viscosity is within the above-mentioned range, the varnish is easy to handle during the coating or the film formation, and the varnish is less repelled and has excellent leveling property, and therefore a good film may be obtained.

As necessary, an anti-oxidizing agent, a filler, a dye, a pigment, a coupling agent such as a silane coupling agent, a primer, a flame retardant, a defoaming agent, a leveling agent, a rheology control agent (flow-promoting agent), a releasing agent, and the like may be added to the varnish of the polyimide of the present invention.

As necessary, an inorganic particle such as silica may be mixed into the polyimide obtained from the polyimide precursor of the present invention and the polyimide of the present invention. Examples of the mixing method include, but not limited to, a method in which an inorganic particle is dispersed in a polymerization solvent, and then a polyimide precursor is polymerized in the solvent; a method in which a polyimide precursor solution and an inorganic particle are mixed; a method in which a polyimide precursor solution and an inorganic particle dispersion are mixed; a method in which an inorganic particle is mixed into a polyimide solution; and a method in which an inorganic particle dispersion is mixed into a polyimide solution. A silica-containing polyimide may be obtained by imidizing a polyimide precursor in a silica-dispersed polyimide precursor solution in which silica is dispersed by any one of these methods; or by mixing a polyimide solution with a silica particle or a silica-dispersed solution, and then heating and drying the mixture to remove the solvent therefrom. As for the inorganic particle to be dispersed in the polyimide, a silica particle may be added to the polyimide. As for the silica particle to be added, the particle size is preferably 100 nm or less, more preferably 50 nm or less, particularly preferably 30 nm or less. When the particle size of the silica particle to be added is more than 100 nm, the polyimide may be white-turbid. Additionally, in the case where a silica particle dispersion is used, “ORGANOSILICASOL DMAc-ST (primary particle size: 10-15 nm, dispersion solvent: N,N-dimethylacetamide) solid content: 20-21%” made by Nissan Chemical Industries, Ltd., and the like may be used, for example.

The polyimide obtained from the polyimide precursor of the present invention and the polyimide of the present invention may have preferably, but not limited to, a coefficient of linear thermal expansion from 50° C. to 300° C., furthermore to 350° C., and furthermore to 400° C., of 30 ppm/K or less, more preferably 25 ppm/K or less, more preferably 24 ppm/K or less, more preferably 22 ppm/K or less, particularly preferably 20 ppm/K or less, more preferably 18 ppm/K or less, when the polyimide is formed into a film, and have a very low coefficient of linear thermal expansion up to a high temperature. When the coefficient of linear thermal expansion is great, the difference in coefficient of linear thermal expansion between the polyimide and a conductive material such as a metal is great, and therefore a trouble such as an increase in warpage may occur during the formation of a circuit board.

The polyimide obtained from the polyimide precursor of the present invention and the polyimide of the present invention may have preferably, but not limited to, a total light transmittance (average light transmittance at wavelengths of 380 nm to 780 nm) of 85% or more, more preferably 86% or more, more preferably 87% or more, particularly preferably 88% or more, in the form of a film having a thickness of 10 μm, and have excellent optical transparency. When the total light transmittance is low, the light source must be bright, and therefore a problem of more energy required, or the like may arise in the case where the polyimide is used in display application, or the like.

As for a film formed of the polyimide of the present invention, the thickness of the film is preferably 1 μm to 250 μm, more preferably 1 μm to 150 μm, more preferably 1 μm to 50 μm, particularly preferably 1 μm to 30 μm, although it varies depending on the intended use. When the polyimide film is too thick, the light transmittance may be low in the case where the polyimide film is used in applications where light passes through the polyimide film.

The polyimide obtained from the polyimide precursor of the present invention and the polyimide of the present invention may have preferably, but not limited to, a 5% weight loss temperature of 490° C. or more, more preferably 495° C. or more, more preferably 500° C. or more, particularly preferably 503° C. or more. In the case where a gas barrier film, or the like is formed on the polyimide for the formation of a transistor on the polyimide, or the like, swelling may occur between the polyimide and the barrier film due to outgassing associated with the decomposition of the polyimide, or the like when the heat resistance is low.

The polyimide obtained from the polyimide precursor of the present invention and the polyimide of the present invention have excellent properties such as high transparency, bending resistance and high heat resistance, and have a very low coefficient of linear thermal expansion up to a high temperature, and therefore the polyimides may be suitably used in the applications of transparent substrate for display, transparent substrate for touch panel, or substrate for solar battery.

One example of a method for producing a polyimide film/base laminate, or a polyimide film with the use of the polyimide precursor of the present invention will be described hereinafter. However, the method is not limited to the method as described below.

For example, a varnish of the polyimide precursor of the present invention is flow-cast on a base of ceramic (glass, silicon, or alumina), metal (copper, aluminum, or stainless steel), heat-resistant plastic film (polyimide), or the like, and dried at a temperature of 20° C. to 180° C., preferably 20° C. to 150° C., by the use of hot air or infrared ray in a vacuum, in an inert gas such as nitrogen, or in air. And then, the obtained polyimide precursor film is heated and imidized at a temperature of 200° C. to 500° C., more preferably about 250° C. to about 450° C., by the use of hot air or infrared ray in a vacuum, in an inert gas such as nitrogen, or in air, wherein the polyimide precursor film is on the base, or alternatively, the polyimide precursor film is peeled from the base and fixed at the edges, to provide a polyimide film/base laminate, or a polyimide film. The thermal imidization is preferably performed in a vacuum or in an inert gas so as to prevent oxidation and degradation of the obtained polyimide film. The thermal imidization may be performed in air if the thermal imidization temperature is not too high. At this point, the thickness of the polyimide film (the polyimide film layer, in the case of a polyimide film/base laminate) is preferably 1 μm to 250 μm, more preferably 1 μm to 150 μm, in view of the transportability in the subsequent steps.

The imidization reaction of the polyimide precursor may also be performed by chemical treatment in which the polyimide precursor is immersed in a solution containing a dehydrating/cyclizing agent such as acetic anhydride in the presence of a tertiary amine such as pyridine and triethylamine, instead of the thermal imidization by heat treatment as described above. Alternatively, a partially-imidized polyimide precursor may be prepared by adding the dehydrating/cyclizing agent to the varnish of the polyimide precursor in advance and stirring the varnish, and then flow-casting the varnish on a base and drying it. A polyimide film/base laminate, or a polyimide film may be obtained by further heating the partially-imidized polyimide precursor as described above.

A flexible conductive substrate may be obtained by forming a conductive layer on one surface or both surfaces of the polyimide film/base laminate or the polyimide film thus obtained.

A flexible conductive substrate may be obtained by the following methods, for example. As for the first method, the polyimide film is not peeled from the base in the “polyimide film/base” laminate, and a conductive layer of a conductive material (metal or metal oxide, conductive organic material, conductive carbon, or the like) is formed on the surface of the polyimide film by sputtering, vapor deposition, printing, or the like, to provide a conductive laminate of “conductive layer/polyimide film/base”. And then, as necessary, the “conductive layer/polyimide film” laminate is peeled from the base, to provide a transparent and flexible conductive substrate which consists of the “conductive layer/polyimide film” laminate.

As for the second method, the polyimide film is peeled from the base in the “polyimide film/base” laminate to obtain the polyimide film, and then a conductive layer of a conductive material (metal or metal oxide, conductive organic material, conductive carbon, or the like) is formed on the surface of the polyimide film in the same way as in the first method, to provide a transparent and flexible conductive substrate which consists of the “conductive layer/polyimide film” laminate or the “conductive layer/polyimide film/conductive layer” laminate.

In the first and the second methods, a gas barrier layer against water vapor, oxygen, or the like, and an inorganic layer such as a light-controlling layer may be formed on the surface of the polyimide film by sputtering, vapor deposition, gel-sol process, or the like, as necessary, before the conductive layer is formed.

In addition, a circuit may be suitably formed on the conductive layer by photolithography process, various printing processes, ink-jet process, or the like.

The substrate of the present invention has a circuit of a conductive layer on a surface of a polyimide film formed of the polyimide of the present invention, optionally with a gas barrier layer or an inorganic layer therebetween, as necessary. The substrate is flexible, and excellent in high transparency, bending resistance and heat resistance, and also has a very low coefficient of linear thermal expansion up to a high temperature and excellent solvent resistance, and therefore a fine circuit may be easily formed thereon. Accordingly, the substrate may be suitably used as a substrate for a display, a touch panel, or a solar battery.

More specifically, a flexible thin-film transistor is produced by further forming a transistor (inorganic transistor, or organic transistor) on the substrate by vapor deposition, various printing processes, ink-jet process, or the like, and is suitably used as a liquid crystal device for display device, an EL device, or a photoelectric device.

### EXAMPLES

The present invention will be further described hereinafter with reference to Examples and Comparative Examples. However, the present invention is not limited to the Examples as described below.

In each of the Examples as described below, the evaluations were conducted by the following methods.

### <Evaluation of Varnish of Polyimide Precursor>

[Logarithmic Viscosity]

A polyimide precursor solution at a concentration of 0.5 g/dL was prepared by diluting the varnish with the solvent used in the polymerization, and the logarithmic viscosity was determined by the measurement of the viscosity at 30° C. using an Ubbelohde viscometer.

### <Evaluation of Polyimide Film>

[Total Light Transmittance]

The total light transmittance (average light transmittance at 380 nm to 780 nm) of the polyimide film having a thickness of 10 μm were measured using a UV-visible spectrophotometer V-650DS made by JASCO Corporation.

[Modulus of Elasticity, Elongation at Break]

The polyimide film having a thickness of 10 μm was cut to the dumbbell shape of IEC450 standard, which was used as a test piece, and the initial modulus of elasticity and the elongation at break were measured at a distance between chucks of 30 mm and a tensile speed of 2 mm/min using a TENSILON made by Orientec Co., Ltd.

[Coefficient of Linear Thermal Expansion (CTE)]

The polyimide film having a thickness of 10 μm was cut to a rectangle having a width of 4 mm, which was used as a test piece, and the test piece was heated to 500° C. at a distance between chucks of 15 mm, a load of 2 g and a temperature-increasing rate of 20° C./min using a TMA/SS6100 made by SII Nanotechnology Inc. The coefficient of linear thermal expansion from 50° C. to 400° C. was determined from the obtained TMA curve.

[5% Weight Loss Temperature]

The polyimide film having a thickness of 10 μm was used as a test piece, and the test piece was heated from 25° C. to 600° C. at a temperature-increasing rate of 10° C./min in a flow of nitrogen using a thermogravimetric analyzer (Q5000IR) made by TA Instruments Inc. The 5% weight loss temperature was determined from the obtained weight curve.

The abbreviations, purities, etc. of the raw materials used in each of the Examples as described below are as follows.

[Diamine Component]

DABAN: 4,4′-diaminobenzanilide [purity: 99.90% (GC analysis)]
PPD: p-phenylenediamine [purity: 99.9% (GC analysis)]
TFMB: 2,2′-bis(trifluoromethyl)benzidine [purity: 99.83% (GC analysis)]
4-APTP: N,N′-bis(4-aminophenyl)terephthalamide [purity: 99.95% (GC analysis)]
4,4′-ODA: 4,4′-oxydianiline [purity: 99.9% (GC analysis)]
3,4′-ODA: 3,4′-oxydianiline
BAPB: 4,4′-bis(4-aminophenoxy)biphenyl [purity: 99.93% (HPLC analysis)]
TPE-R: 1,3-bis(4-aminophenoxy)benzene
MPD: m-phenylenediamine

[Tetracarboxylic Acid Component]

Three types of norbornane-2-spiro-α-cyclopentanone-α′-spiro-2″-norbornane-5,5″,6,6″-tetracarboxylic dianhydride (CpODA-1 to CpODA-3) was provided as the tetracarboxylic acid component.

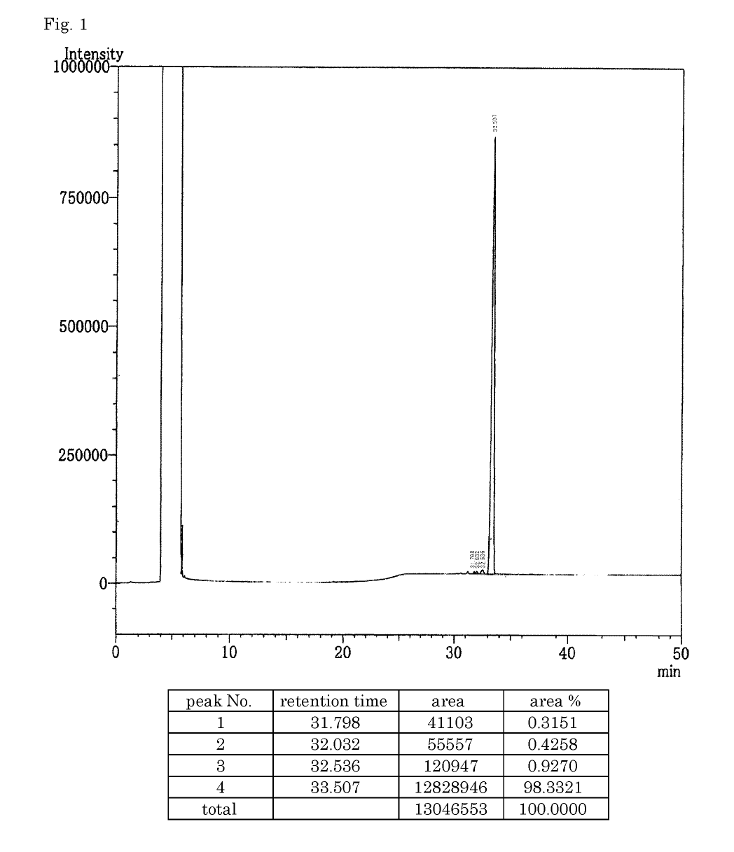

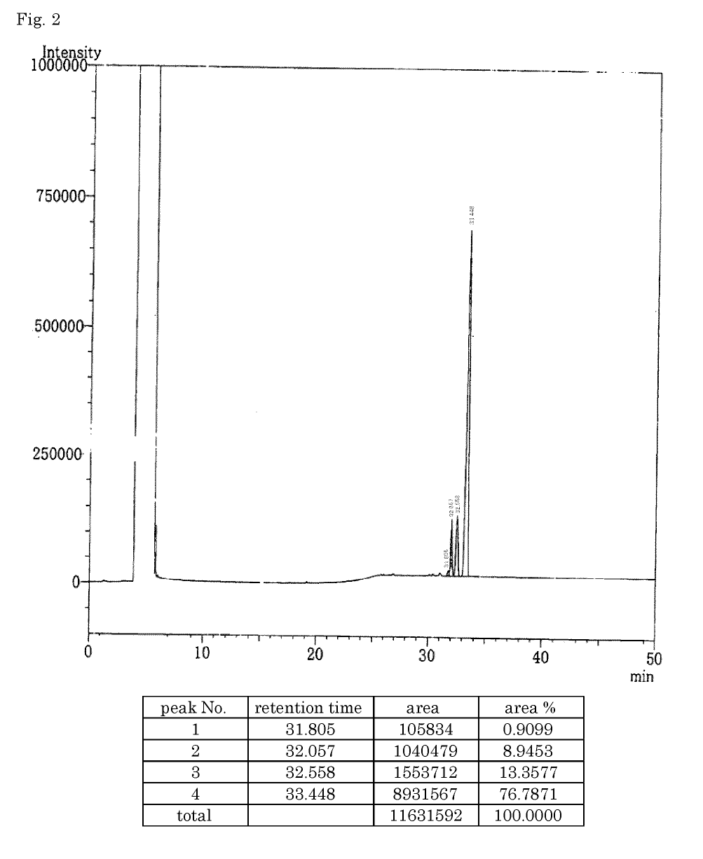

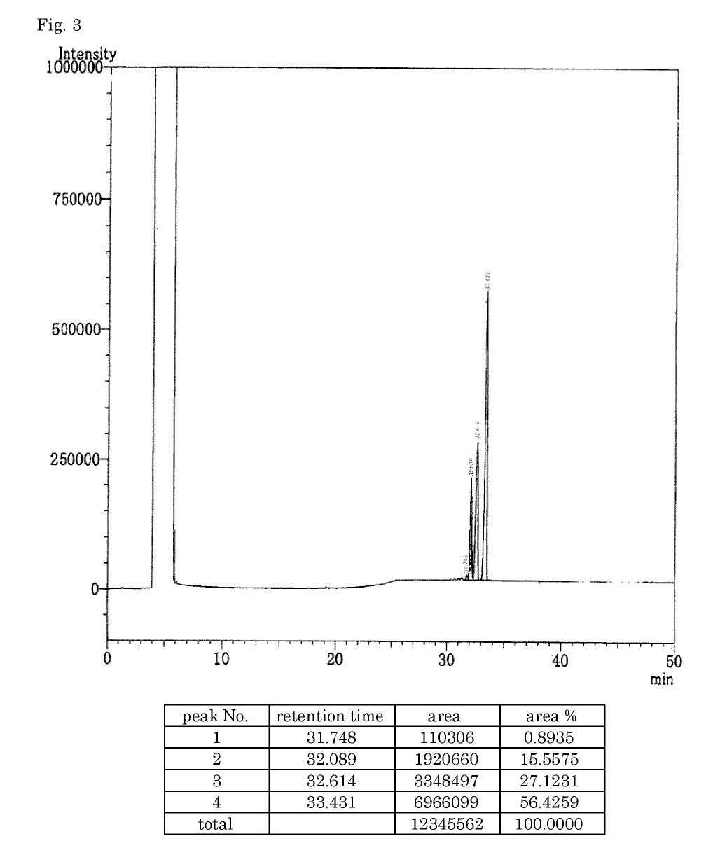

CpODA-1: norbornane-2-spiro-α-cyclopentanone-α′-spiro-2″-norbornane-5,5″,6,6″-tetracarboxylic dianhydride wherein the ratio of the peak area in the retention time 33.4-33.5 is 98.3% relative to the total peak area in the retention time 31.7-33.5 in the gas chromatography analysis. The gas chromatogram of CpODA-1 is shown in FIG. 1.
CpODA-2: norbornane-2-spiro-α-cyclopentanone-α′-spiro-2″-norbornane-5,5″,6,6″-tetracarboxylic dianhydride wherein the ratio of the peak area in the retention time 33.4-33.5 is 76.8% relative to the total peak area in the retention time 31.7-33.5 in the gas chromatography analysis. The gas chromatogram of CpODA-2 is shown in FIG. 2.
CpODA-3: norbornane-2-spiro-α-cyclopentanone-α′-spiro-2″-norbornane-5,5″,6,6″-tetracarboxylic dianhydride wherein the ratio of the peak area in the retention time 33.4-33.5 is 56.4% relative to the total peak area in the retention time 31.7-33.5 in the gas chromatography analysis. The gas chromatogram of CpODA-3 is shown in FIG. 3.

### (GC Analysis Conditions)

Measurement sample: Solution prepared by dissolving 0.25 g of norbornane-2-spiro-α-cyclopentanone-α′-spiro-2″-norbornane-5,5″,6,6″-tetracarboxylic dianhydride in 5 mL of N,N-dimethylacetamide;
Column: “Rtx-5 Amine” made by SHIMADZU GLC Ltd. (length: 30 m);
Column temperature: Temperature is increased from 50° C. to 300° C. at the rate of 10° C./min, and maintained at 300° C.;

### Carrier gas: He;

Flow rate (flow rate of carrier gas): 10 mL/min;
Measuring device: GC-2010 type made by SHIMADZU CORPORATION;
Sample inlet temperature: 290° C.;
Detector temperature: 310° C.;
Amount of injected sample: 1 μL.

[Solvent]

NMP: N-methyl-2-pyrrolidone

The structural formulas of the tetracarboxylic acid components and the diamine components used in Examples and Comparative Examples are shown in Table 1.

TABLE 1

| Tetracarboxylic dianhydride | Diamine | |
|---|---|---|
| 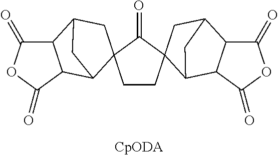 [SMILES: O=C1OC(=O)C2C1C1CC2C2(CCC3(CC4CC3C3C(=O)OC(=O)C43)C2=O)C1] | 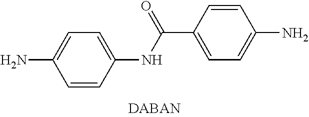 [SMILES: Nc1ccc(NC(=O)c2ccc(N)cc2)cc1] | 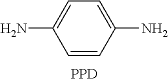 |

| | |
|---|---|
| 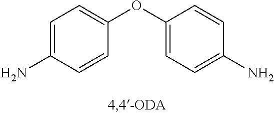 [SMILES: Nc1ccc(Oc2ccc(N)cc2)cc1] | 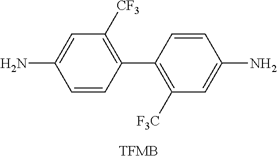 [SMILES: Nc1ccc(-c2ccc(N)cc2C(F)(F)F)c(C(F)(F)F)c1] |
| 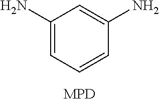 | 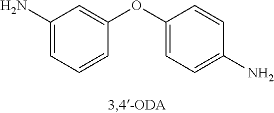 [SMILES: Nc1ccc(Oc2cccc(N)c2)cc1] |

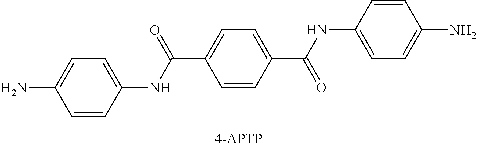 [SMILES: Nc1ccc(NC(=O)c2ccc(C(=O)Nc3ccc(N)cc3)cc2)cc1]

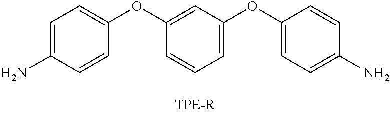 [SMILES: Nc1ccc(Oc2cccc(Oc3ccc(N)cc3)c2)cc1]

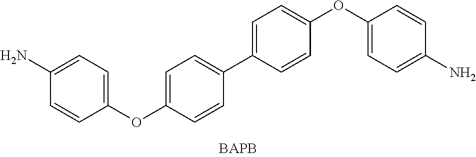 [SMILES: Nc1ccc(Oc2ccc(-c3ccc(Oc4ccc(N)cc4)cc3)cc2)cc1]

### Example 1

CpODA-1 was provided as the tetracarboxylic acid component. 2.27 g (10 mmol) of DABAN was placed in a reaction vessel, which was purged with nitrogen gas, and 29.83 g of N-methyl-2-pyrrolidone was added thereto such that the total mass of the charged monomers (total mass of the diamine component and the carboxylic acid component) was 17 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 2

CpODA-1 was provided as the tetracarboxylic acid component. 1.59 g (7 mmol) of DABAN and 0.32 g (3 mmol) of PPD were placed in a reaction vessel, which was purged with nitrogen gas, and 28.07 g of N-methyl-2-pyrrolidone was added thereto such that the total mass of the charged monomers (total mass of the diamine component and the carboxylic acid component) was 17 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 31

CpODA-1 was provided as the tetracarboxylic acid component. 0.91 g (4 mmol) of DABAN and 0.65 g (6 mmol) of PPD were placed in a reaction vessel, which was purged with nitrogen gas, and 26.60 g of N-methyl-2-pyrrolidone was added thereto such that the total mass of the charged monomers (total mass of the diamine component and the carboxylic acid component) was 18 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 4

CpODA-1 was provided as the tetracarboxylic acid component. 1.59 g (7 mmol) of DABAN and 0.96 g (3 mmol) of TFMB were placed in a reaction vessel, which was purged with nitrogen gas, and 25.56 g of N-methyl-2-pyrrolidone was added thereto such that the total mass of the charged monomers (total mass of the diamine component and the carboxylic acid component) was 20 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 51

CpODA-1 was provided as the tetracarboxylic acid component. 1.14 g (5 mmol) of DABAN, 0.43 g (4 mmol) of PPD and 0.20 g (1 mmol) of 4,4′-ODA were placed in a reaction vessel, which was purged with nitrogen gas, and 27.39 g of N-methyl-2-pyrrolidone was added thereto such that the total mass of the charged monomers (total mass of the diamine component and the carboxylic acid component) was 17 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor solution was heated on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 61

CpODA-1 was provided as the tetracarboxylic acid component. 0.91 g (4 mmol) of DABAN, 0.43 g (4 mmol) of PPD and 0.64 g (2 mmol) of TFMB were placed in a reaction vessel, which was purged with nitrogen gas, and 23.28 g of N-methyl-2-pyrrolidone was added thereto such that the total mass of the charged monomers (total mass of the diamine component and the carboxylic acid component) was 20 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 71

CpODA-1 was provided as the tetracarboxylic acid component. 1.73 g (5 mmol) of 4-APTP and 1.60 g (5 mmol) of TFMB were placed in a reaction vessel, which was purged with nitrogen gas, and 28.68 g of N,N-dimethylacetamide was added thereto such that the total mass of the charged monomers (total mass of the diamine component and the carboxylic acid component) was 20 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 81

CpODA-1 was provided as the tetracarboxylic acid component. 0.91 g (4 mmol) of DABAN, 0.54 g (5 mmol) of PPD and 0.20 g (1 mmol) of 3,4′-ODA were placed in a reaction vessel, which was purged with nitrogen gas, and 25.01 g of N-methyl-2-pyrrolidone was added thereto such that the total mass of the charged monomers (total mass of the diamine component and the carboxylic acid component) was 18 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 9

CpODA-1 was provided as the tetracarboxylic acid component. 0.91 g (4 mmol) of DABAN, 0.54 g (5 mmol) of PPD and 0.37 g (1 mmol) of BAPB were placed in a reaction vessel, which was purged with nitrogen gas, and 22.64 g of N-methyl-2-pyrrolidone was added thereto such that the total mass of the charged monomers (total mass of the diamine component and the carboxylic acid component) was 20 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 101

CpODA-1 was provided as the tetracarboxylic acid component. 0.91 g (4 mmol) of DABAN, 0.54 g (5 mmol) of PPD and 0.29 g (1 mmol) of TPE-R were placed in a reaction vessel, which was purged with nitrogen gas, and 25.42 g of N-methyl-2-pyrrolidone was added thereto such that the total mass of the charged monomers (total mass of the diamine component and the carboxylic acid component) was 18 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 11

CpODA-1 was provided as the tetracarboxylic acid component. 0.91 g (4 mmol) of DABAN, 0.54 g (5 mmol) of PPD and 0.11 g (1 mmol) of MPD were placed in a reaction vessel, which was purged with nitrogen gas, and 24.60 g of N-methyl-2-pyrrolidone was added thereto such that the total mass of the charged monomers (total mass of the diamine component and the carboxylic acid component) was 18 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 12

CpODA-1 was provided as the tetracarboxylic acid component. 0.91 g (4 mmol) of DABAN, 0.32 g (3 mmol) of PPD and 0.32 g (3 mmol) of MPD were placed in a reaction vessel, which was purged with nitrogen gas, and 24.55 g of N-methyl-2-pyrrolidone was added thereto such that the total mass of the charged monomers (total mass of the diamine component and the carboxylic acid component) was 18 mass %, and then the mixture was stirred at room temperature for 1 hour. 3.84 g (10 mmol) of CpODA-1 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-1.

### Example 131

CpODA-2 was provided as the tetracarboxylic acid component. 1.59 g (7 mmol) of DABAN and 0.96 g (3 mmol) of TFMB were placed in a reaction vessel, which was purged with nitrogen gas, and 25.56 g of N-methyl-2-pyrrolidone was added thereto such that the total mass of the charged monomers (total mass of the diamine component and the carboxylic acid component) was 20 mass %, and then the mixture was stirred at room temperature for 1 hour. 3.84 g (10 mmol) of CpODA-2 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Example 14

CpODA-2 was provided as the tetracarboxylic acid component. 0.91 g (4 mmol) of DABAN, 0.54 g (5 mmol) of PPD and 0.32 g (1 mmol) of TFMB were placed in a reaction vessel, which was purged with nitrogen gas, and 22.44 g of N-methyl-2-pyrrolidone was added thereto such that the total mass of the charged monomers (total mass of the diamine component and the carboxylic acid component) was 20 mass %, and then the mixture was stirred at room temperature for 1 hour. 3.84 g (10 mmol) of CpODA-2 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Example 15

CpODA-2 was provided as the tetracarboxylic acid component. 0.68 g (3 mmol) of DABAN, 0.65 g (6 mmol) of PPD and 0.32 g (1 mmol) of TFMB were placed in a reaction vessel, which was purged with nitrogen gas, and 21.96 g of N-methyl-2-pyrrolidone was added thereto such that the total mass of the charged monomers (total mass of the diamine component and the carboxylic acid component) was 20 mass %, and then the mixture was stirred at room temperature for 1 hour. 3.84 g (10 mmol) of CpODA-2 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Example 161

CpODA-2 was provided as the tetracarboxylic acid component. 1.14 g (5 mmol) of DABAN, 0.43 g (4 mmol) of PPD and 0.20 g (1 mmol) of 4,4′-ODA were placed in a reaction vessel, which was purged with nitrogen gas, and 27.39 g of N-methyl-2-pyrrolidone was added thereto such that the total mass of the charged monomers (total mass of the diamine component and the carboxylic acid component) was 17 mass %, and then the mixture was stirred at room temperature for 1 hour. 3.84 g (10 mmol) of CpODA-2 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor solution was heated on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Example 17

CpODA-2 was provided as the tetracarboxylic acid component. 0.68 g (3 mmol) of DABAN, 0.65 g (6 mmol) of PPD and 0.20 g (1 mmol) of 4,4′-ODA were placed in a reaction vessel, which was purged with nitrogen gas, and 26.22 g of N-methyl-2-pyrrolidone was added thereto such that the total mass of the charged monomers (total mass of the diamine component and the carboxylic acid component) was 17 mass %, and then the mixture was stirred at room temperature for 1 hour. 3.84 g (10 mmol) of CpODA-2 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor solution was heated on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Comparative Example 1

CpODA-3 was provided as the tetracarboxylic acid component. 2.27 g (10 mmol) of DABAN was placed in a reaction vessel, which was purged with nitrogen gas, and 29.83 g of N-methyl-2-pyrrolidone was added thereto such that the total mass of the charged monomers (total mass of the diamine component and the carboxylic acid component) was 17 mass %, and then the mixture was stirred at room temperature for 1 hour. 3.84 g (10 mmol) of CpODA-3 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Comparative Example 2

CpODA-3 was provided as the tetracarboxylic acid component. 1.59 g (7 mmol) of DABAN and 0.32 g (3 mmol) of PPD were placed in a reaction vessel, which was purged with nitrogen gas, and 28.07 g of N-methyl-2-pyrrolidone was added thereto such that the total mass of the charged monomers (total mass of the diamine component and the carboxylic acid component) was 17 mass %, and then the mixture was stirred at room temperature for 1 hour. 3.84 g (10 mmol) of CpODA-3 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Comparative Example 31

CpODA-3 was provided as the tetracarboxylic acid component. 0.91 g (4 mmol) of DABAN and 0.65 g (6 mmol) of PPD were placed in a reaction vessel, which was purged with nitrogen gas, and 26.60 g of N-methyl-2-pyrrolidone was added thereto such that the total mass of the charged monomers (total mass of the diamine component and the carboxylic acid component) was 18 mass %, and then the mixture was stirred at room temperature for 1 hour. 3.84 g (10 mmol) of CpODA-3 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Comparative Example 4

CpODA-3 was provided as the tetracarboxylic acid component. 1.59 g (7 mmol) of DABAN and 0.96 g (3 mmol) of TFMB were placed in a reaction vessel, which was purged with nitrogen gas, and 25.56 g of N-methyl-2-pyrrolidone was added thereto such that the total mass of the charged monomers (total mass of the diamine component and the carboxylic acid component) was 20 mass %, and then the mixture was stirred at room temperature for 1 hour. 3.84 g (10 mmol) of CpODA-3 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Comparative Example 51

CpODA-3 was provided as the tetracarboxylic acid component. 1.14 g (5 mmol) of DABAN, 0.43 g (4 mmol) of PPD and 0.20 g (1 mmol) of 4,4′-ODA were placed in a reaction vessel, which was purged with nitrogen gas, and 27.39 g of N-methyl-2-pyrrolidone was added thereto such that the total mass of the charged monomers (total mass of the diamine component and the carboxylic acid component) was 17 mass %, and then the mixture was stirred at room temperature for 1 hour. 3.84 g (10 mmol) of CpODA-3 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor solution was heated on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Comparative Example 61

CpODA-3 was provided as the tetracarboxylic acid component. 0.91 g (4 mmol) of DABAN, 0.43 g (4 mmol) of PPD and 0.64 g (2 mmol) of TFMB were placed in a reaction vessel, which was purged with nitrogen gas, and 23.28 g of N-methyl-2-pyrrolidone was added thereto such that the total mass of the charged monomers (total mass of the diamine component and the carboxylic acid component) was 20 mass %, and then the mixture was stirred at room temperature for 1 hour. 3.84 g (10 mmol) of CpODA-3 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

### Comparative Example 71

CpODA-3 was provided as the tetracarboxylic acid component. 1.73 g (5 mmol) of 4-APTP and 1.60 g (5 mmol) of TFMB were placed in a reaction vessel, which was purged with nitrogen gas, and 28.68 g of N,N-dimethylacetamide was added thereto such that the total mass of the charged monomers (total mass of the diamine component and the carboxylic acid component) was 20 mass %, and then the mixture was stirred at room temperature for 1 hour. 3.84 g (10 mmol) of CpODA-3 was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 410° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-2.

TABLE 2-1

| | | Example | Example | Example | Example | Example | Example |
|---|---|---|---|---|---|---|---|
| | | 1 | 2 | 3 | 4 | 5 | 6 |
| Polyimide precursor | | | | | | | |
| Tetracarboxylic | CpODA-1 (ratio of peak | 10 | 10 | 10 | 10 | 10 | 10 |
| acid component | area in the retention | | | | | | |
| (mmol) | time 33.4-33.5:98.3%) | | | | | | |
| | CpODA-2 (ratio of peak | | | | | | |
| | area in the retention | | | | | | |
| | time 33.4-33.5:76.8%) | | | | | | |
| | CpODA-3 (ratio of peak | | | | | | |
| | area in the retention | | | | | | |
| | time 33.4-33.5:56.4%) | | | | | | |
| Diamine | DABAN | 10 | 7 | 4 | 7 | 5 | 4 |
| component | PPD | | 3 | 6 | | 4 | 4 |
| (mmol) | TFMB | | | | 3 | | 2 |
| | 4-APTP | | | | | | |
| | 4,4′-ODA | | | | | 1 | |
| | 3,4′-ODA | | | | | | |
| | BAPB | | | | | | |
| | TPE-R | | | | | | |
| | MPD | | | | | | |
| Polyimide film | | | | | | | |
| Total light transmittance (%) | | 86 | 85 | 88 | 86 | 87 | 86 |
| Modulus of elasticity (GPa) | | 7.4 | 6.9 | 6 | 6.3 | 6 | 5.8 |
| Elongation at break (%) | | 6 | 5 | 7 | 11 | 11 | 6 |
| Coefficient of linear thermal expansion | | 10 | 13 | 15 | 16 | 21 | 15 |
| (ppm/K) (50-400° C.) | | | | | | | |
| 5% weight loss temperature (° C.) | | 505 | 503 | 503 | 497 | 502 | 491 |
| | | Example | Example | Example | Example | Example | Example |
| | | 7 | 8 | 9 | 10 | 11 | 12 |
| Polyimide precursor | | | | | | | |
| Tetracarboxylic | CpODA-1 (ratio of peak | 10 | 10 | 10 | 10 | 10 | 10 |
| acid component | area in the retention | | | | | | |
| (mmol) | time 33.4-33.5:98.3%) | | | | | | |
| | CpODA-2 (ratio of peak | | | | | | |
| | area in the retention | | | | | | |
| | time 33.4-33.5:76.8%) | | | | | | |
| | CpODA-3 (ratio of peak | | | | | | |
| | area in the retention | | | | | | |
| | time 33.4-33.5:56.4%) | | | | | | |
| Diamine | DABAN | | 4 | 4 | 4 | 4 | 4 |
| component | PPD | | 5 | 5 | 5 | 5 | 3 |
| (mmol) | TFMB | 5 | | | | | |
| | 4-APTP | 5 | | | | | |
| | 4,4′-ODA | | | | | | |
| | 3,4′-ODA | | 1 | | | | |
| | BAPB | | | 1 | | | |
| | TPE-R | | | | 1 | | |
| | MPD | | | | | 1 | 3 |

| | | | | | | |
|---|---|---|---|---|---|---|
| Polyimide film | | | | | | |
| Total light transmittance (%) | 87 | 87 | 87 | 86 | 88 | 88 |
| Modulus of elasticity (GPa) | 6.6 | 5.5 | 5.5 | 5.2 | 5.8 | 5 |
| Elongation at break (%) | 13 | 13 | 8 | 9 | 7 | 5 |
| Coefficient of linear thermal expansion | 27 | 16 | 18 | 21 | 19 | 22 |
| (ppm/K) (50-400° C.) | | | | | | |
| 5% weight loss temperature (° C.) | — | 504 | 504 | 503 | 503 | 499 |

TABLE 2-2

| | | Example | Example | Example | Example | Example | Comparative | Comparative |
|---|---|---|---|---|---|---|---|---|
| | | 13 | 14 | 15 | 16 | 17 | Example 1 | Example 2 |
| Polyimide precursor | | | | | | | | |
| Tetracarboxylic | CpODA-1 (ratio of peak | | | | | | | |
| acid component | area in the retention | | | | | | | |
| (mmol) | time 33.4-33.5:98.3%) | | | | | | | |
| | CpODA-2 (ratio of peak | 10 | 10 | 10 | 10 | 10 | | |
| | area in the retention | | | | | | | |
| | time 33.4-33.5:76.8%) | | | | | | | |
| | CpODA-3 (ratio of peak | | | | | | 10 | 10 |
| | area in the retention | | | | | | | |
| | time 33.4-33.5:56.4%) | | | | | | | |
| Diamine | DABAN | 7 | 4 | 3 | 5 | 3 | 10 | 7 |
| component | PPD | | 5 | 6 | 4 | 6 | | 3 |
| (mmol) | TFMB | 3 | 1 | 1 | | | | |
| | 4-APTP | | | | | | | |
| | 4,4′-ODA | | | | 1 | 1 | | |
| | 3,4′-ODA | | | | | | | |
| | BAPB | | | | | | | |
| | TPE-R | | | | | | | |
| | MPD | | | | | | | |

| | | | | | | | |
|---|---|---|---|---|---|---|---|
| Polyimide film | | | | | | | |
| Total light transmittance (%) | 85 | 87 | 87 | 86 | 87 | 86 | 85 |
| Modulus of elasticity (GPa) | 4.9 | 4.8 | 4.8 | 4.7 | 4.3 | 5.7 | 5.1 |
| Elongation at break (%) | 14 | 8 | 6 | 11 | 7 | 6 | 6 |
| Coefficient of linear thermal expansion | 26 | 27 | 24 | 27 | 27 | 19 | 25 |
| (ppm/K) (50-400° C.) | | | | | | | |
| 5% weight loss temperature (° C.) | — | 492 | 493 | 496 | 496 | 500 | 500 |

| | | Comparative | Comparative | Comparative | Comparative | Comparative |
|---|---|---|---|---|---|---|
| | | Example 3 | Example 4 | Example 5 | Example 6 | Example 7 |
| Polyimide precursor | | | | | | |
| Tetracarboxylic | CpODA-1 (ratio of peak | | | | | |
| acid component | area in the retention | | | | | |
| (mmol) | time 33.4-33.5:98.3%) | | | | | |
| | CpODA-2 (ratio of peak | | | | | |
| | area in the retention | | | | | |
| | time 33.4-33.5:76.8%) | | | | | |
| | CpODA-3 (ratio of peak | 10 | 10 | 10 | 10 | 10 |
| | area in the retention | | | | | |
| | time 33.4-33.5:56.4%) | | | | | |
| Diamine | DABAN | 4 | 7 | 5 | 4 | |
| component | PPD | 6 | | 4 | 4 | |
| (mmol) | TFMB | | 3 | | 2 | 5 |
| | 4-APTP | | | | | 5 |
| | 4,4′-ODA | | | 1 | | |
| | 3,4′-ODA | | | | | |
| | BAPB | | | | | |
| | TPE-R | | | | | |
| | MPD | | | | | |

| | | | | | |
|---|---|---|---|---|---|
| Polyimide film | | | | | |
| Total light transmittance (%) | 88 | 88 | 86 | 87 | 87 |
| Modulus of elasticity (GPa) | 3.5 | 4.3 | 4.2 | 3.9 | 5.1 |
| Elongation at break (%) | 9 | 14 | 17 | 4 | 25 |
| Coefficient of linear thermal expansion | 26 | 44 | 39 | 42 | 33 |
| (ppm/K) (50-400° C.) | | | | | |
| 5% weight loss temperature (° C.) | 502 | 491 | 497 | 494 | 496 |

As can be seen from the results shown in Table 2-1 and Table 2-2, the polyimides of the present invention, in which norbornane-2-spiro-α-cyclopentanone-α′-spiro-2″-norbornane-5,5″,6,6″-tetracarboxylic dianhydride wherein the ratio of the peak area in the retention time 33.4-33.5 is 98.3% (CpODA-1) or 76.8% (CpODA-2) relative to the total peak area in the retention time 31.7-33.5 is used, have a comparable transparency and high heat resistance, and have a smaller coefficient of linear thermal expansion from 50° C. to 400° C. as compared with the polyimides of Comparative Examples, in which norbornane-2-spiro-α-cyclopentanone-α′-spiro-2″-norbornane-5,5″,6,6″-tetracarboxylic dianhydride wherein the ratio of the peak area in the retention time 33.4-33.5 is 56.4% relative to the total peak area in the retention time 31.7-33.5 (CpODA-3) is used.

As described above, the polyimide obtained from the polyimide precursor of the present invention (the polyimide of the present invention) has excellent optical transparency, heat resistance, and bending resistance, and has a low coefficient of linear thermal expansion up to a high temperature, and therefore the polyimide film of the present invention may be suitably used as a transparent substrate for use in a display, and the like, which is colorless and transparent, and on which a fine circuit can be formed.

### INDUSTRIAL APPLICABILITY

According to the present invention, there may be provided a polyimide having excellent properties such as high transparency and high heat resistance, and having a very low coefficient of linear thermal expansion up to a high temperature; and a precursor thereof. The polyimide obtained from the polyimide precursor, and the polyimide have high transparency and a low coefficient of linear thermal expansion up to a high temperature, which allows easy formation of a fine circuit, and have solvent resistance, and therefore the polyimides may be suitably used for the formation of a substrate for use in a display, or the like, in particular.

1. A polyimide precursor obtained from:
a tetracarboxylic acid component comprising norbornane-2-spiro-α-cyclopentanone-α′-spiro-2″-norbornane-5,5″,6,6″-tetracarboxylic dianhydride, or a derivative thereof, and
a diamine component comprising a diamine, or a derivative thereof,
wherein the norbornane-2-spiro-α-cyclopentanone-α′-spiro-2″-norbornane-5,5″,6,6″-tetracarboxylic dianhydride is characterized in that the ratio of the peak area in the retention time 33.4-33.5 min is 60% or more relative to the total peak area in the retention time 31.7-33.5 min in a gas chromatogram obtained by conducting gas chromatography analysis under the following conditions:
Measurement sample: Solution prepared by dissolving norbornane-2-spiro-α-cyclopentanone-α′-spiro-2″-norbornane-5,5″,6,6″-tetracarboxylic dianhydride in N,N-dimethylacetamide;
Column: “Rtx-5 Amine” made by SHIMADZU GLC Ltd. (length: 30 m);
Column temperature: Temperature is increased from 50° C. to 300° C. at the rate of 10° C./min, and maintained at 300° C.;
Carrier gas: He;
Flow rate (flow rate of carrier gas): 10 mL/min;
Sample inlet temperature: 290° C.;
Detector temperature: 310° C.

2. The polyimide precursor according to claim 1, wherein the polyimide precursor comprises at least one repeating unit represented by the following chemical formula (1): 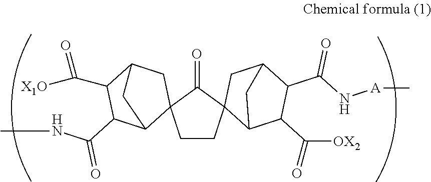
wherein A is a divalent group of an aromatic diamine or an aliphatic diamine, from which amino groups have been removed; and X₁ and X₂ are each independently hydrogen, an alkyl group having 1 to 6 carbon atoms, or an alkylsilyl group having 3 to 9 carbon atoms,
as the repeating unit derived from norbornane-2-spiro-α-cyclopentanone-α′-spiro-2″-norbornane-5,5″,6,6″-tetracarboxylic dianhydride or a derivative thereof, and a diamine or a derivative thereof.

3. The polyimide precursor according to claim 2, wherein the polyimide precursor comprises at least one repeating unit of the chemical formula (1) in which A is a group represented by the following chemical formula (2): 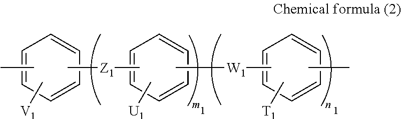
wherein m₁ and n₁ are integers of 0 or more, and m₁ independently represents 0 to 3 and n₁ independently represents 0 to 3; V₁, U₁ and T₁ each independently represent at least one selected from the group consisting of hydrogen atom, methyl group and trifluoromethyl group; and Z₁ and W₁ each independently represent direct bond, or at least one selected from the group consisting of groups represented by the formulas: —NHCO—, —CONH—, —COO— and —OCO—.

4. The polyimide precursor according to claim 3, wherein the polyimide precursor comprises at least two of repeating units of the chemical formula (1) in which A is a group represented by the chemical formula (2).

5. A polyimide obtained from:
a tetracarboxylic acid component comprising norbornane-2-spiro-α-cyclopentanone-α′-spiro-2″-norbornane-5,5″,6,6″-tetracarboxylic dianhydride, or a derivative thereof, and
a diamine component comprising a diamine, or a derivative thereof,
wherein the norbornane-2-spiro-α-cyclopentanone-α′-spiro-2″-norbornane-5,5″,6,6″-tetracarboxylic dianhydride is characterized in that the ratio of the peak area in the retention time 33.4-33.5 min is 60% or more relative to the total peak area in the retention time 31.7-33.5 min in a gas chromatogram obtained by conducting gas chromatography analysis under the following conditions:
Measurement sample: Solution prepared by dissolving norbornane-2-spiro-α-cyclopentanone-α′-spiro-2″-norbornane-5,5″,6,6″-tetracarboxylic dianhydride in N,N-dimethylacetamide;
Column: “Rtx-5 Amine” made by SHIMADZU GLC Ltd. (length: 30 m);
Column temperature: Temperature is increased from 50° C. to 300° C. at the rate of 10° C./min, and maintained at 300° C.;
Carrier gas: He;
Flow rate (flow rate of carrier gas): 10 mL/min;
Sample inlet temperature: 290° C.;
Detector temperature: 310° C.

6. The polyimide according to claim 5, wherein the polyimide comprises at least one repeating unit represented by the following chemical formula (3): 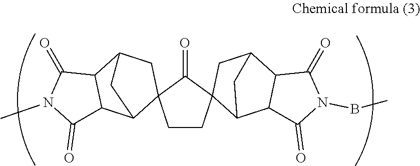
wherein B is a divalent group of an aromatic diamine or an aliphatic diamine, from which amino groups have been removed, as the repeating unit derived from norbornane-2-spiro-α-cyclopentanone-α′-spiro-2″-norbornane-5,5″,6,6″-tetracarboxylic dianhydride or a derivative thereof, and a diamine or a derivative thereof.

7. The polyimide according to claim 6, wherein the polyimide comprises at least one repeating unit of the chemical formula (3) in which B is a group represented by the following chemical formula (4): 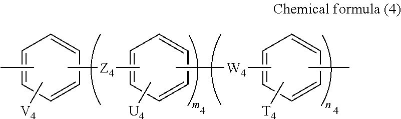
wherein m₄ and n₄ are integers of 0 or more, and m₄ independently represents 0 to 3 and n₄ independently represents 0 to 3; V₄, U₄ and T₄ each independently represent at least one selected from the group consisting of hydrogen atom, methyl group and trifluoromethyl group; and Z₄ and W₄ each independently represent direct bond, or at least one selected from the group consisting of groups represented by the formulas: —NHCO—, —CONH—, —COO— and —OCO—.

8. A polyimide obtained from the polyimide precursor according to claim 1.

9. A polyimide film obtained from the polyimide precursor according to claim 1.

10. A varnish comprising the polyimide precursor according to claim 1.

11. A polyimide film obtained using a varnish comprising the polyimide precursor according to claim 1.

12. A substrate for a display, a touch panel or a solar battery formed of the polyimide obtained from the polyimide precursor according to claim 5.

13. The polyimide according to claim 6, wherein the polyimide has a 5% weight loss temperature of 490° C. or more, wherein the polyimide is heated from 25° C. to 600° C. at a temperature-increasing rate of 10° C./min in a flow of nitrogen.

14. A varnish comprising the polyimide according to claim 5.

15. A polyimide film obtained using a varnish comprising the polyimide according to claim 5.
